(19) United States
(12) Patent Application Publication
(10) Pub. No.: US 2008/0243322 A1
(43) Pub. Date: Oct. 2, 2008

(54) CONTROL DEVICE AND METHOD OF HYBRID VEHICLE

(75) Inventors: Hidetoshi NOBUMOTO, Hiroshima (JP); Kiyotaka Mamiya, Hiroshima (JP); Seiji Esaki, Hiroshima (JP); Taizou Shoya, Hiroshima (JP); Takayuki Ueda, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/037,210

(22) Filed: Feb. 26, 2008

(30) Foreign Application Priority Data
Mar. 30, 2007 (JP) 2007-090049
Mar. 30, 2007 (JP) 2007-090050

(51) Int. Cl. G06F 19/00

(52) U.S. Cl. 701/22; 903/940

(57) ABSTRACT

There are provided a driving-state determination device to determine a driving state of a hybrid vehicle, and a driving-source selection device to select a driving source from an engine a first motor generator, and a second motor generator based on determination of the driving-state determination device so as to provide the highest driving efficiency as a whole of the vehicle. Herein, the first and second motor generators are configured so that a high-efficiency driving operation area of the first motor generator is set on a higher-speed side relative to a high-efficiency driving operation area of the second motor generator. Accordingly, there can be provided a control device of a hybrid vehicle that can improve the driving efficiency as a whole of the vehicle properly.

### BACKGROUND OF THE INVENTION

The present invention relates to a control device and method of a hybrid vehicle, and particularly to a control device and method of a hybrid vehicle that can improve an efficiency of regeneration of a power energy, ensuring a necessary driving force, by using two motor generators.

Recently, hybrid vehicles equipped with an engine and a motor have been developed for low emission and energy saving. Japanese Patent Laid-Open Publication No. 2000-295711, for example, discloses a hybrid vehicle equipped with first and second motors, in which the motors function as a driving resource or a generator and that function is selectable in accordance with driving states. The hybrid vehicle disclosed in the patent publication has been invented to improve the energy efficiency by reducing the amount of electricity generation and output of the motors.

In this case where a driving torque is produced and outputted with combination of two motors and an engine, it is preferable that the motors be configured to have different output characteristics from one another to cope with various vehicle driving states. For example, the combination of a motor providing a high efficiency at a relatively high speed area and another motor providing a high efficiency at a relatively low speed area may improve the efficiency as a whole of the vehicle at a wider driving area. The hybrid vehicle of the above-described patent publication, however, discloses nothing about these points.

Meanwhile, U.S. Pat. No. 5,289,890 discloses a technology in which two motor generators having different driving efficiency are provided at an identical driving shaft, and the driving efficiency can be improved at both driving areas of a low speed area and a high speed area. This technology is just for application to an electric vehicle (equipped with only a motor as a driving resource), which is not considered for application to the so-called hybrid vehicle equipped with the engine. It is preferable that either one of the motor generators be directly coupled to the engine to enable cranking of the engine in the hybrid vehicle. In this case, there may be provided a first motor generator whose rotational speed is restricted by a rotational speed of an engine shaft, and a second motor generator whose rotational speed is not influenced by the rotational speed of the engine shaft. The above-described US patent publication, however, discloses nothing as to what kind of driving efficient characteristics should be applied to these two motor generators.

### SUMMARY OF THE INVENTION

The present invention has been devised in view of the above-described matters, and an object of the present invention is to provide a control device and method of a hybrid vehicle that can improve the driving efficiency as a whole of the vehicle properly.

According to the present invention, there is provided a control device of a hybrid vehicle, comprising an engine operative to output a driving torque to the vehicle, a first motor generator operative to generate electricity and output a driving torque to the vehicle, the first motor generator being directly coupled to the engine, a second motor generator operative to generate electricity and output a driving torque to the vehicle, a battery operative to supply electricity to the first and second motor generators, the battery being charged by the first and second motor generators, a driving-state determination device operative to determine a driving state of the vehicle, and a driving-source selection device operative to select a driving source from the engine, the first motor generator, and the second motor generator based on determination of the driving-state determination device so as to provide the highest driving efficiency as a whole of the vehicle, wherein the first and second motor generators are configured so that a high-efficiency driving operation area of the first motor generator is set on a higher-speed side relative to a high-efficiency driving operation area of the second motor generator.

According to the present invention, since the first and second motor generators having different high-efficiency driving operation areas are applied and the driving source is selected by the driving-source selection device so as to provide the highest driving efficiency as a whole of the vehicle, the appropriate selection of the driving source can be provided in accordance with the vehicle driving states, thereby improving the driving efficiency as a whole of the vehicle. Herein, in the first motor generator directly coupled to the engine for the engine cranking, its rotational speed may be generally influenced (restricted) by the rotational speed of the engine shaft during the electricity generation or torque assist. Since the rotational speed of the engine shaft does not lower below an idling speed while the engine operates, the first motor generator operates at a relatively higher-speed driving area relative to the second motor generator. According to the present invention, since the first and second motor generators are further configured so that the high-efficiency driving operation area of the first motor generator is set on the higher-speed side relative to the high-efficiency driving operation area of the second motor generator, the driving efficiency as a whole of the vehicle can be improved further properly, so that a properly efficient electricity generation or torque assist can be provided.

According to an embodiment of the present invention, the engine and the first motor generator are coupled to a driving shaft of the vehicle via a transmission, and the driving-source selection device is configured so as to determine a driving efficiency of the first motor generator and compare that with a driving efficiency of the second motor generator for each speed ratio of the transmission. Thereby, the first motor generator can be used as the driving source for a middle-high speed in which the driving efficiency increases in proportion to the rotational speed of the engine, and comparison with the driving efficiency of the second motor generator can be conducted by determining the high-efficiency operation area that is changeable for each speed ratio. Accordingly, the more accurate appropriate distribution can be attained.

According to another embodiment of the present invention, the control device further comprises a speed-ratio setting device operative to set the speed ratio of the transmission at a specified speed ratio that enables the first motor generator to provide a highest driving efficiency thereof when the driving-source selection device selects the first motor generator as the driving source. Thereby, since the speed ratio is set so as to provide the highest driving efficiency of the first motor generator when the engine is not operated, the driving efficiency as a whole of the vehicle can be further improved.

According to another embodiment of the present invention, the speed-ratio setting device is configured to set the speed ratio of the transmission at a specified speed ratio that enables a fuel-consumption efficiency of the engine to provide a highest efficiency when the driving-source selection device selects the engine and the first motor generator as the driving source without an operation of the engine. Thereby, the fuel-consumption efficiency of the engine has priority in a driving area where the engine operation is needed. Herein, the meaning of “when the driving-source selection device selects the engine and the first motor generator as the driving source” includes a case where the engine and both of the first and second motor generators are selected by the driving-source selection device.

According to another embodiment of the present invention, a motor output shaft of the second motor generator is coupled to an output shaft of the transmission, a first clutch is provided between the first motor generator and the transmission, a second clutch is provided at the motor output shaft of the second motor generator, and there is provided a clutch control device operative to control the first and second clutches so as to disconnect the first clutch when the driving-source selection device selects only the second motor generator as the driving source and to disconnect the second clutch when the driving-source selection device excludes the second motor generator from the driving source. Thereby, in the driving area where only the second motor generator is operated (at a low-speed vehicle starting, or a reverse vehicle driving, mainly), the driving torque of the second motor generator can be transmitted to the vehicle driving wheel without receiving any resistance of the engine or the first motor generator. Further, in the driving area where the second motor generator is not operated (at a middle-high speed driving, mainly), the driving torque of the engine or the first motor generator can be transmitted to the vehicle driving wheel without receiving any resistance of the second motor generator. Accordingly, the driving efficiency as a whole of the vehicle can be improved.

According to another embodiment of the present invention, the control device further comprises a first temperature detection device operative to detect a temperature of the first motor generator, a second temperature detection device operative to detect a temperature of the second motor generator, and a motor-load distribution device operative to determine each temperature state of the first and second motor generators based on detection signals of the first and second temperature detection devices and to change distribution of load of the motor generators in such a manner that when the temperature of the motor generators that are selected as the driving source is a specified temperature or greater, the load of the motor generator having a higher temperature is reduced, substantially maintaining a total torque. Thereby, since the distribution of load of the motor generators is changed in such a manner that when the temperature of the motor generators selected is the specified temperature or greater, the load of the motor generator having the higher temperature is reduced, substantially maintaining the total torque, the damage of the motor generator, such as the copper wear, can be restrained properly, maintaining the total torque, and the driving efficiency as a whole can be maintained with a lower consumption of electricity. Herein, “the load of the motor generator” means any physical quantity such as an electric power that is to be supplied to the motor generator for producing a driving torque, or a torque or a rotational speed that is necessary for the motor generator to generate the electric power.

According to another embodiment of the present invention, the motor-load distribution device is configured so that the specific temperature is adjustable in accordance with demanded load to the motor generators in such a manner that the specific temperature is adjusted to be lower when the demanded load is greater. There is generally a tendency that the temperature of the motor generator increases when the demanded load is greater. Accordingly, since the specific temperature is adjusted in accordance with the demanded load, the decrease of the driving efficiency due to the increase of the temperature can be restrained effectively.

According to another embodiment of the present invention, there are provided a first rotational speed detection device operative to detect a rotational speed of the first motor generator and a second rotational speed detection device operative to detect a rotational speed of the second motor generator, and the motor-load distribution device is configured to increase the distribution of the load of the motor generator having a higher rotational speed when the temperature of the motor generators that are selected as the driving source is a specified temperature or greater. Thereby, the output can be obtained efficiently by increasing the distribution of the load of the motor generator with less copper wear. That is, the damage of the copper wear may increase when the motor generator has the higher temperature and higher electricity supply, and the efficiency decrease may be primarily influenced by the copper wear damage. Accordingly, the efficiency decrease can be restrained properly by increasing the load distribution of the motor generator having the higher rotational speed.

Further, according to another aspect of the present invention, there is provided a control method of a hybrid vehicle that includes an engine operative to output a driving torque to the vehicle, a first motor generator operative to generate electricity and output a driving torque to the vehicle, the first motor generator being directly coupled to the engine, a second motor generator operative to generate electricity and output a driving torque to the vehicle, a high-efficiency driving operation area of the second motor generator being set on a lower-speed side relative to a high-efficiency driving operation area of the first motor generator, and a battery operative to supply electricity to the first and second motor generators, the battery being charged by the first and second motor generators, the control method comprising a first step of selecting a driving source from the engine, the first motor generator, and the second motor generator so as to provide the highest driving efficiency as a whole of the vehicle, and a second step of operate the selected driving source that is selected by the first step. The present control method of a hybrid vehicle can provide substantially the same functions and effects as the above-described control device.

Other features, aspects, and advantages of the present invention will become apparent from the following description which refers to the accompanying drawings.

### BRIEF DESCRIPTION OF THE DRAWINGS

FIG. 1 is a diagram showing a schematic constitution of a hybrid vehicle according to a first embodiment of the present invention.

FIG. 2 is a block diagram according to the embodiment of FIG. 1.

FIG. 3 is an image diagram of a control map based on a demanded torque and a charging amount.

FIG. 4 is a graph of an engine fuel-consumption-efficiency ratio map based on a torque and an engine (rotational) speed.

FIG. 5 is a graph showing a driving-efficiency operation area of a first motor generator based on a torque and a motor rotational speed.

FIG. 6 is a graph showing a driving-efficiency operation area of a second motor generator based on a torque and a motor rotational speed.

FIG. 7 is a flowchart showing an example of a vehicle driving control of the hybrid vehicle according to the embodiment of the present invention.

FIG. 8 is a flowchart of a driving processing subroutine for an engine-joint operation of FIG. 7.

FIG. 9 is a flowchart of a driving processing subroutine for a motor-single operation of FIG. 7.

FIG. 10 is a flowchart of a driving processing subroutine for an engine-single operation of FIG. 7.

FIG. 11 is a flowchart of a charging processing subroutine of FIG. 7.

FIG. 12 is a flowchart of an example of regeneration processing according to the present embodiment.

FIG. 13 is a block diagram according to a second embodiment, which corresponds to FIG. 2 of the first embodiment.

FIG. 14 is a graph of the engine fuel-consumption-efficiency ratio map based on the torque and the engine speed according to the second embodiment.

FIG. 15 is a graph showing the driving-efficiency operation area of the first motor generator based on the torque and the motor rotational speed according to the second embodiment.

FIG. 16 is a graph showing the driving-efficiency operation area of the second motor generator based on the torque and the motor rotational speed according to the second embodiment.

FIG. 17 is a flowchart showing an example of the vehicle driving control of the hybrid vehicle according to the second embodiment of the present invention.

FIG. 18 is a flowchart showing an example of the vehicle driving control of the hybrid vehicle according to the second embodiment of the present invention.

FIG. 19 is a flowchart of a driving processing subroutine for an engine-joint operation at a low temperature of FIG. 17.

FIG. 20 is a flowchart of a driving processing subroutine for a motor-single operation at the low temperature of FIG. 17.

FIG. 21 is a flowchart of a driving processing subroutine for an engine-single operation at a low temperature of FIG. 17.

FIG. 22 is a flowchart of a driving processing subroutine for the engine-joint operation at a high temperature of FIG. 17.

FIG. 23 is a flowchart of a driving processing subroutine for the motor-single operation at the high temperature of FIG. 17.

FIG. 24 is a flowchart of a charging processing subroutine of FIG. 17.

FIG. 25 is a flowchart of the charging processing subroutine of FIG. 17.

FIG. 26 is a flowchart of the charging processing subroutine of FIG. 17.

FIG. 27 is a flowchart of regeneration processing at a deceleration according to the second embodiment.

FIG. 28 is a flowchart of the regeneration processing at the deceleration according to the second embodiment.

FIG. 29 is a flowchart of the regeneration processing at the deceleration according to the second embodiment.

### DETAILED DESCRIPTION OF THE INVENTION

Hereinafter, preferred embodiments of the present invention will be described referring to the accompanying drawings.

### Embodiment 1

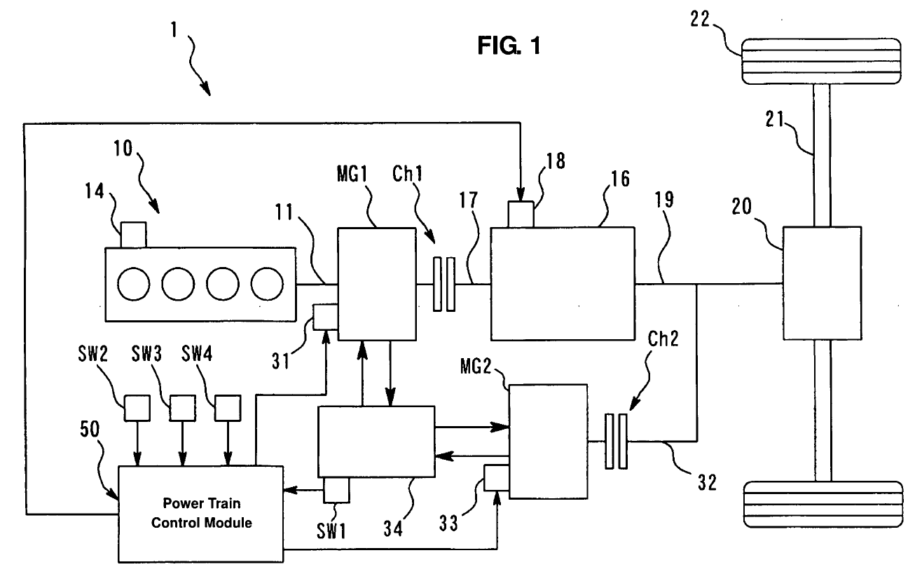

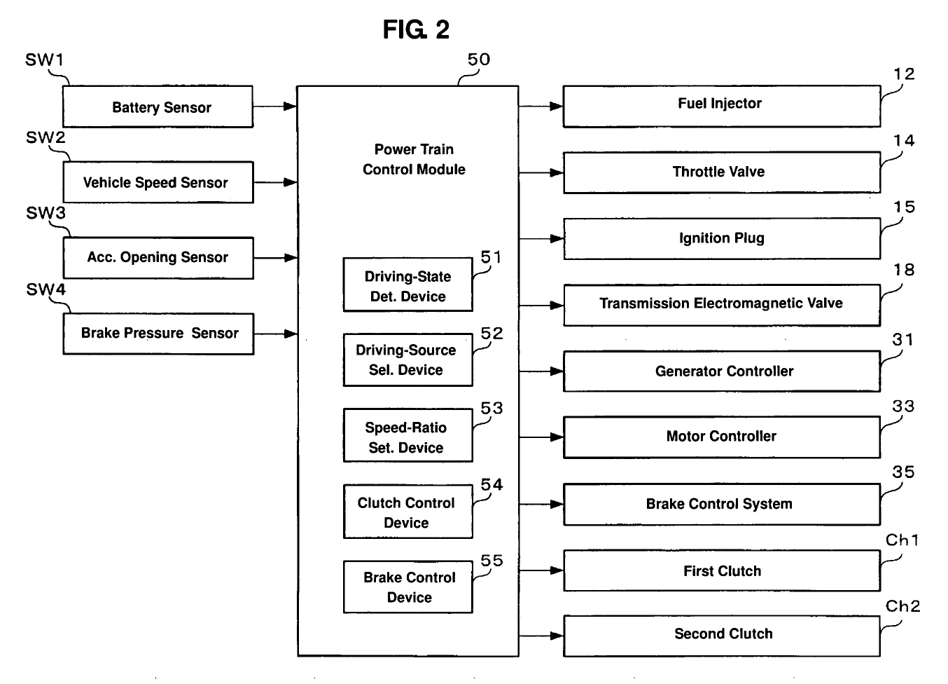

FIG. 1 is a diagram showing a schematic constitution of a hybrid vehicle according to a first embodiment of the present invention. FIG. 2 is a block diagram according to the embodiment of FIG. 1.

Referring to FIGS. 1 and 2, a hybrid vehicle 1 is a parallel hybrid type of vehicle, which comprises an engine 10 and first and second motor generators MG1, MG2, as a driving source, and a PCM (Power Train Control Module) 50 to control the driving sources 10, MG1, MG2.

The engine 10 comprises a crank shaft 11 and additionally a fuel injector 12, a throttle valve 14 and an ignition plug as shown in FIG. 2. The crank shaft 11 is coupled to an input shaft 17 of a transmission 16 of the hybrid vehicle 1 via the first motor generator MG1 and a first clutch Ch1. The transmission 16 is configured to change the speed ratio thereof by using a transmission electromagnet valve 18. Further, an output shaft 19 of the transmission 16 is coupled to a differential mechanism 20. Thus, a driving force of the engine 10 is transmitted to a driving wheel 22 via the differential mechanism 20 and a driving shaft 21.

The first motor generator MG1 is comprised of an electricity generator that is directly coupled to the crank shaft 11. The first motor generator MG1 is configured to generate the electricity as the driving source of an engine output from the crank shaft 11 and to output the driving force to the input shaft 17 of the transmission 16 via the first clutch Ch1. The first motor generator MG1 is equipped with a generator controller 31, which is controlled by a control of the PCM 50 so as to adjust the electricity generation amount and an output torque.

The second motor generator MG2 is comprised of an electricity generator that is operative to be the driving source at a vehicle starting or a reverse vehicle driving and to conduct an energy regeneration at a vehicle deceleration. A motor output shaft 32 of the second motor generator MG2 is operationally coupled to the output shaft 19 of the transmission 16 via the second clutch Ch2. The second motor generator MG2 is equipped with a motor controller 33, which is controlled by the control of the PCM 50 so as to adjust the electricity generation amount and an output torque.

A battery 34 is connected to the motor generators MG1, MG2. The battery 34 supplies an electric power to the motor generators MG1, MG2 and charges the electric power generated by the motor generators MG1, MG2. Further, the battery 34 is equipped with a battery sensor SW1 to detect the charging amount. The battery sensor SW1 monitors the electric current and voltage of the battery to detect the charging amount.

The hybrid vehicle 1 is equipped with a known brake control system 35 (see FIG. 2) that controls braking of the vehicle at a specified driving state with a frictional brake.

Referring to FIG. 2, the hybrid vehicle 1 is equipped with the battery sensor SW1, a vehicle speed sensor SW2, an accelerator opening sensor SW3, a brake pressure sensor SW4 and so on to detect vehicle driving state. These sensors SW1-SW4 are connected to the PCM 50 as input elements.

Further, to the PCM 50 are connected, as output elements, the fuel injector 12, throttle valve 14, ignition plug 15, transmission electromagnet valve 18, generator controller 31, motor controller 33, first and second clutches Ch1, Ch2, and brake control system 35.

The PCM 50, which is a microprocessor comprising CPU, memories and others, reads detection signals from the input elements, executes specified processing, and outputs control signals to the output elements with function of program modules. In an exampled illustrated, the PCM 50 performs respective functions as a driving-state determination device 51, a driving-source selection device 52, a speed-ratio setting device 53, a clutch control device 54, and a brake control device 55.

The driving-state determination device 51 determines a driving state of the hybrid vehicle 1. This device 51, for example, determines an existence of demand for charging or an allowance of charging based on the detection signal of the battery sensor SW1, calculates a demanded torque of an operator based on the detection signals of the vehicle speed sensor SW2 and the accelerator opening sensor SW3, and calculates the regenerative braking torque at the vehicle deceleration based on the detection signals of the vehicle speed sensor SW2 and the brake pressure sensor SW4.

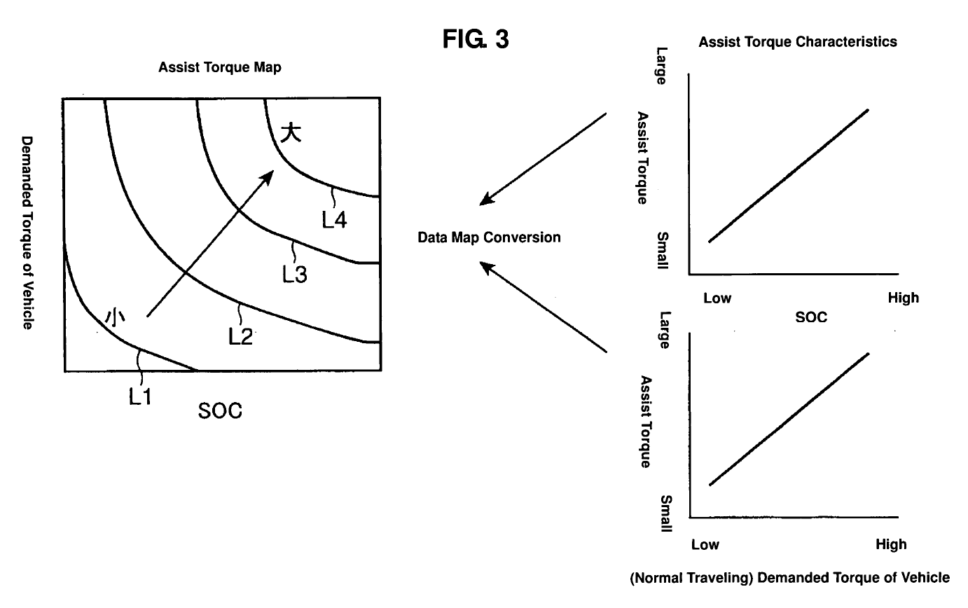

The driving-source selection device 52 selects the engine 10, the first motor generators MG1, or the second motor generator MG2 as the driving source based on control maps M1-M5 that are memorized in the memory previously. Next, the control maps M1-M5 will be described referring to FIGS. 3-6.

FIG. 3 is an image diagram of the control map M1 based on the demanded torque and a charging amount.

Referring to FIG. 3, a torque that can be outputted by the respective motor generators MG1, MG2 (hereinafter, referred to as “assist torque”) is determined by the charging amount (SOC) of the battery 34. The assist torque by the motor generators MG1, MG2 at the normal vehicle traveling state is in proportion to the demanded torque of the hybrid vehicle 1 (see a lower right graph of FIG. 3). Herein, these characteristics are made as data through previous experiments or the like, and a data-map transfer is conducted, thereby an assist torque map at the left of FIG. 3 that is based on the demanded torque of the vehicle and the above-described SOC can be obtained. Accordingly, in the present embodiment, the combination of the demanded torque and the remaining amount of SOC is set based on plural traveling areas that are split by some contour lines L1-L4 in the graph and memorized in the memory as the control map M1. Thereby, the driving-source selection device 52 can select the proper driving source (mainly, determine necessity of the engine operation).

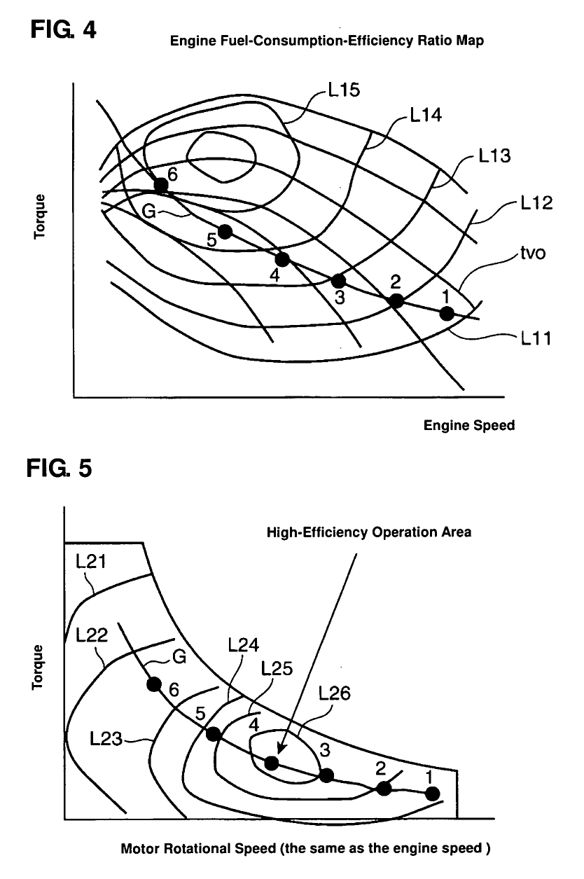

Further, the control maps M2-M4 shown in FIGS. 4 and 5 are provided for selection of the motor generators MG1, MG2 according to the present embodiment.

FIG. 4 is a graph of an engine fuel-consumption-efficiency ratio map based on the torque and the engine (rotational) speed. In the graph, plural areas based on the torque and the engine speed as the fuel-consumption-efficiency ratio of the engine 10 are set by plural contour lines L11-L15. According to the present embodiment, the combination of the torque and the engine speed is memorized in the memory as the control map M2 based on this graph, and the comparison with the data of the control map M2 enables the driving-source selection device 52 to determine the necessity of the engine operation. Herein, since the fuel-consumption-efficiency ratio differs depending on the speed ratio of the transmission 16 even at the same torque and engine speed, a speed ratio graph G (figures in the graph indicate the speed ratio) is set in the control map M2 as shown in FIG. 4 so as to specify the fuel-consumption-efficiency ratio for each speed ratio.

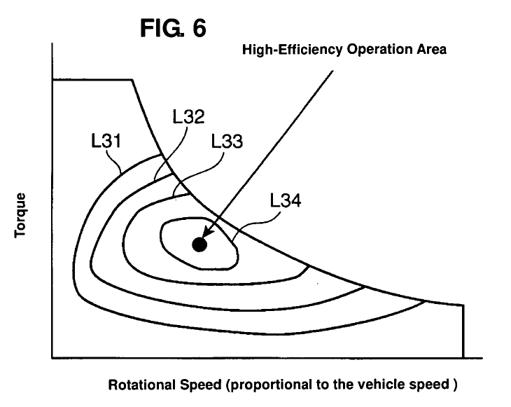

Next, the high-efficiency operation area of the first and second motor generators MG1, MG2 will be described. Herein, “high-efficiency operation area” means a driving area where the efficiency is the highest in the characteristics map based on the torque and the engine speed. This high-efficiency operation area is selected as the highest-efficiency area in the graph shown in FIGS. 5 and 6.

FIG. 5 is a graph showing the driving-efficiency operation area of the first motor generator based on the torque and the motor rotational speed.

Referring to FIG. 5, in this graph, plural areas based on the torque and the motor speed as the driving efficiency ratio of the first motor generator MG1 are set by plural contour lines L21-L26. According to the present embodiment, the combination of the torque and the motor speed is memorized in the memory as the control map M3 based on this graph, and the comparison with the data of the control map M4, which will be described below, enables determination of the necessity of operation of each of the first and second motor generators MG1, MG2. Herein, the first motor generator MG1 is directly coupled to the crank shaft 11, so the high-efficiency operation area (inside the contour line L26) is set in the middle-speed and low-load area. Also, since the first motor generator MG1 is directly coupled to the crank shaft 11, the driving efficiency of the first motor generator MG1 differs depending on the speed ratio of the transmission 16 even at the same torque and motor rotational speed. Therefore, a speed ratio graph G (figures in the graph indicate the speed ratio) is set in the control map M3 as shown in FIG. 5 so as to specify the driving efficiency of the first motor generator MG1 for each speed ratio.

FIG. 6 is a graph showing the driving-efficiency operation area of the second motor generator based on the torque and the motor rotational speed.

Referring to FIG. 6, in this graph, plural areas based on the torque and the motor speed as the driving efficiency ratio of the second motor generator MG2 are set by plural contour lines L31-L34. According to the present embodiment, the combination of the torque and the motor speed is memorized in the memory as the control map M4 based on this graph, and the comparison with the data of the control map M3 shown in FIG. 5 enables determination of the necessity of operation of each of the first and second motor generators MG1, MG2. Herein, the second motor generator MG2 is operated mainly at the vehicle starting, the reverse vehicle driving, or the light-load driving area, so the high-efficiency operation area (inside the contour line L34) is set at the low-speed and middle-load area.

Herein, in a case where the first and second motor generator MG1, MG2 are used for the energy regeneration, the control map M5 for controlling the charge capacity is memorized in the memory of the PCM 50. This control map M5 is made basically in the same manner as the control map M1 shown in FIG. 3, so detailed descriptions are omitted here.

The speed-ratio setting device 53 is configured to select, based on the control maps M2, M3, either one of the speed ratio that is determined by the fuel-consumption-efficiency ratio of the engine 10 and the speed ratio that is determined by the efficiency operation area of the first motor generator MG1 in accordance with the driving state. As shown in FIGS. 4 and 5, the speed ratio graph G is set in the control maps M2, M3 so as to specify the fuel-consumption-efficiency ratio of the engine 10 and the driving efficiency of the first motor generator MG1 for each speed ratio. Herein, according to the present embodiment, the speed-ratio setting device 53 is configured so that the speed ratio to provide the highest fuel-consumption-efficiency ratio (fuel economy) of the engine 10 is selected with priority in a case where the engine 10 and the first motor generator MG1 are used at the same time as the driving source as shown in the flowcharts described below. As a result, in the driving area where the engine 10 and the first motor generator MG1 are used at the same time as the driving source, the hybrid vehicle 1 is operated in the state where the fuel-consumption-efficiency ratio (fuel economy) becomes the highest.

The clutch control device 54 connects the first clutch Ch1 when the engine 10 or the first motor generator MG1 are operated and disconnects the first clutch Ch1 when any one of the engine 10 and the first motor generator MG1 are not operated as shown in the flowchart described below. Further, the clutch control device 54 connects the second clutch Ch2 when the second motor generator MG2 is operated and disconnects the second clutch Ch2 when the second motor generator MG2 is not operated.

The above-described driving-state determination device 51, driving-source selection device 52, speed-ratio setting device 53, and clutch control device 54 provide the following controls of the hybrid vehicle 1 as shown in Chart 1.

| | CHART 1 | | | | |
|---|---|---|---|---|---|
| | Driving State | | | | |
| | Vehicle Starting, | | | | |
| | Low Load, | Engine Operation | | Engine Regeneration | |
| Driving Source | Reverse Driving | Low Speed | Middle Speed | Low Speed | Middle Speed |
| Engine | Not operated | Operated | Operated | Not operated | Not operated |
| First Motor Generator | Not operated | Operated | Operated | Not operated | Operated |
| Second Motor Generator | Operated | Operated | Not operated | Operated | Not operated |
| First Clutch | Disconnected | Connected | Connected | Disconnected | Connected |
| Second Clutch | Connected | Connected | Disconnected | Connected | Disconnected |

The brake control device 55 controls the brake control system 35 based on results of the determination of the detection signal of the brake pressure sensor SW4 by the driving-state determination device 51.

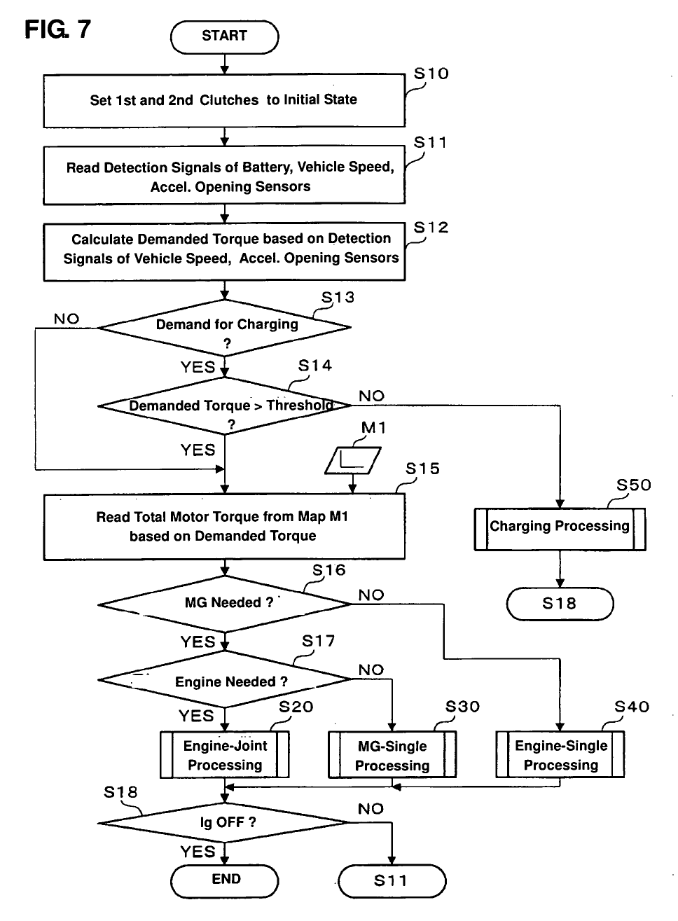

Next, an exemplified driving control of the hybrid vehicle according to the present embodiment will be described referring to FIGS. 7-12.

FIG. 7 is a flowchart showing the exemplified driving control of the hybrid vehicle according to the embodiment of the present invention.

Referring to FIG. 7, this flowchart is executed by the PCM 50 when the ignition switch of the hybrid vehicle 1 is turned on.

When the ignition switch is turned on, the clutch control device 54 of the PCM 50 sets the first and second clutch Ch1, Ch2 to an initial state (step S10). In this initial state, for example, the first clutch is disconnected and the second clutch Ch2 is connected, thereby the torque transmission path is controlled so that the driving force of the second motor generator MG2 can be transmitted to the driving wheel 22 solely. In this state, the driving-state determination device 51 of the PCM 50 reads the detection signals of the battery sensor SW1, vehicle speed sensor SW2 and accelerator opening sensor SW3 (step S11), and calculates the demanded torque of the hybrid vehicle 1 based on the detection signals of the vehicle speed sensor SW2 and accelerator opening sensor SW3 (step S12).

Next, the PCM 50 determines the existence of demand for charging based on the detection signal of the battery sensor SW1 read in the step S11 (step S13). When it is determined that there exists the demand for charging, the PCM 50 determines whether the demanded torque exceeds a specified threshold or not (step S14). This determination is provided to limit the execution of the charging processing only to the case where the demanded torque does not exceed the specified threshold because the first and second motor generators MG1, MG2 need to be operated as the driving source in the case where the demanded torque is rather greater over the specified threshold. When the demanded torque is less than the specified threshold in the step S14, the charging subroutine (step S50), which will be described, is executed, and the control proceeds to step S18.

Meanwhile, when it is determined that the demand for charging does not exist in the step S13 or it is determined that the demanded torque exceeds the specified threshold in the step S14, the control proceeds to the flow in which the respective motor generators MG1, MG2 are operated as the driving source. In this case, the PCM 50 reads the total motor torque from the control map M1 based on the demanded torque of the hybrid vehicle 1 and the charging amount (step S15).

Next, the PCM 50 determines whether the first and second motor generators MG1, MG2 need to be operated or not (step S16). This determination is executed by comparing the charging amount read from the control map M1 of the graph of FIG. 3 with the charging amount based on the detection signal of the battery sensor SW1.

When it is determined that the first and second motor generators MG1, MG2 need to be operated, the PCM 50 further determines whether or not the current driving state is a state where the engine 10 needs to output the driving force (step S17). As shown in Chart 1, at the vehicle starting, the reverse vehicle driving, or the light-load driving area, the engine 10 is not operated and the hybrid vehicle 1 is driven by the second motor generator MG2 solely. Thus, the operation of the engine 10 is executed at a specified rotational speed area where the combustion efficiency is properly high and a properly low emission is expected.

When the current driving state is the state where the engine 10 needs to output the driving force, the driving processing subroutine for the engine-joint operation (step S20) is executed. Meanwhile, when the current driving state is not the state where the engine 10 needs to output the driving force, the driving processing subroutine for the motor-single operation (step S30) is executed. Further, when it is determined that the current driving state is the state where any one of the first and second motor generators MG1, MG2 needs not to output the driving force in the step S16, the driving processing subroutine for the engine-single operation (step S40) is executed.

After the execution of the subroutines S20, S30, S40, the PCM 50 determines whether the ignition switch is turned OFF or not (step S18). When this OFF is determined, the control ends. When the ignition switch is not turned OFF, the control proceeds to the step S11, and the above-described processing is repeated.

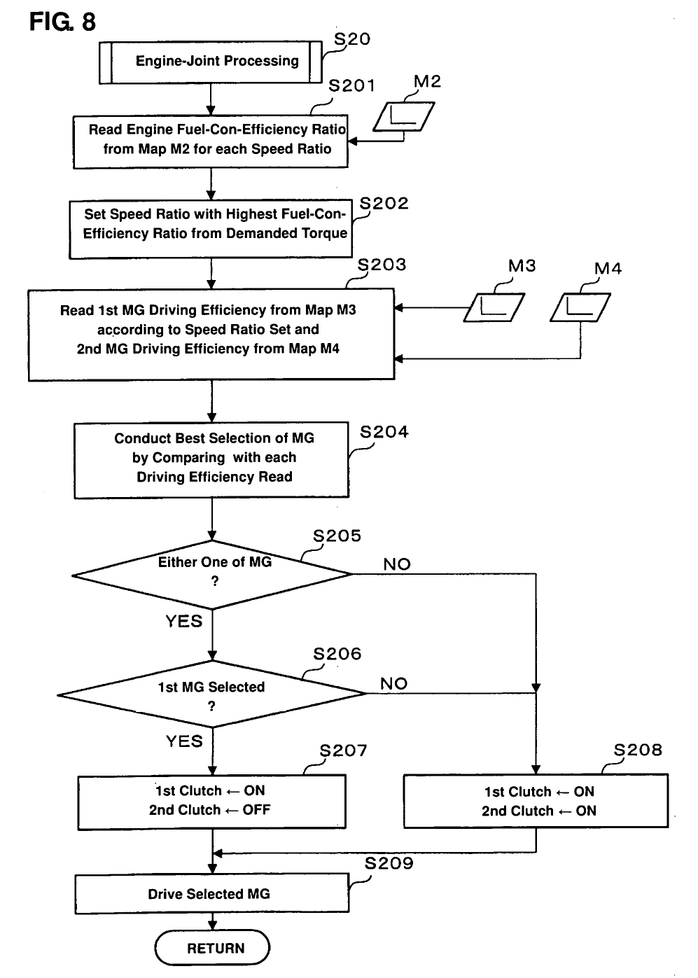

FIG. 8 is a flowchart of the driving processing subroutine for the engine-joint operation (step S20) of FIG. 7.

Referring to FIG. 8, in the driving processing subroutine for the engine-joint operation, the PCM 50 reads the fuel-consumption-efficiency ratio of the engine 10 from the control map M2 of the graph of FIG. 4 for each speed ratio (step S201). Then, the speed-ratio setting device 53 of the PCM 50 sets the speed ratio having the highest fuel-consumption-efficiency ratio based on the demanded torque calculated in the step S12 in the main routine (step S202). Thereby, the transmission electromagnetic valve 18 is driven, so the speed ratio of the transmission 16 is properly changed according to the control executed in the step S202.

Next, the PCM 50 reads the driving efficiency of the first motor generator MG1 according to the speed ratio set in the step S202 based on the control map M3 of the graph of FIG. 5 and also reads the driving efficiency of the second motor generator MG2 from the control map M4 of the graph of FIG. 6 (step S203). The PCM 50 conducts the selection of the motor generators MG1, MG2 by comparing with each driving efficiency read in the step S203 (step S204).

Herein, the PCM 50 calculates the best combined driving efficiency based on the speed ratio set and then selects the motor generator. The “combined driving efficiency” means the driving efficiency that is obtained by distributing the driving efficiency of the first motor generator MG1 corresponding to the selected speed ratio and the driving efficiency of the second motor generator MG2 corresponding to the selected speed according to a specified calculation equation in an optimization method, such as a simplex method. Thus, either one or both of the first and second motor generators MG1, MG2 are selected based on the driving state or the charging amount.

Next, the control of the first and second clutches Ch1, Ch2 are executed based on the selection manner of the first and second motor generators MG1, MG2.

Specifically, the PCM 50 determines whether either one of the motor generators is selected or not (step S205). When either one of the first and second motor generators MG1, MG2 is selected, further determination as to whether the selected one is the first motor generator MG1 or not is conducted (step S206). When that is the first motor generator MG1, the clutch control device 54 of the PCM 50 connects the first clutch Ch1 and disconnects the second clutch Ch2 (step S207).

Meanwhile, when both the first and second motor generators MG1, MG2 are selected in the step S205, or when only the second motor generator MG2 is selected, the clutch control device 54 of the PCM 50 connects both the first and second clutches Ch1, Ch2 (step S208).

Then, the selected motor generator is driven (step S209), and the control returns to the main routine.

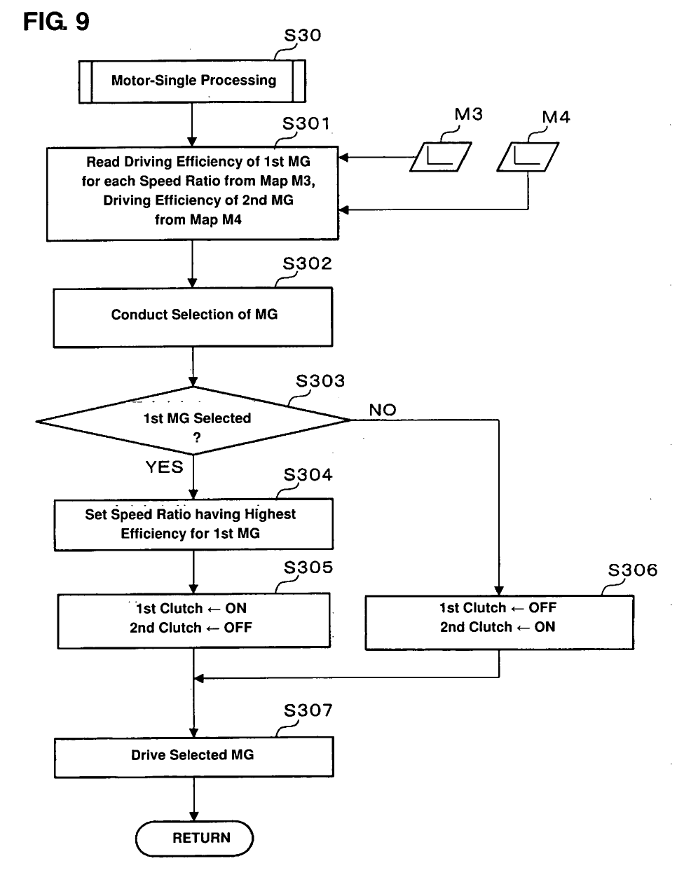

FIG. 9 is a flowchart of the driving processing subroutine for the motor-single operation (step S30) of FIG. 7.

Referring to FIG. 9, in the driving processing subroutine for the motor-single operation, the PCM 50 reads the driving efficiency of the first motor generator MG1 according to each speed ratio from the control map M3 of the graph of FIG. 5, and reads the driving efficiency of the second motor generator MG2 from the control map M4 of the graph of FIG. 6 (step S301). The PCM 50 compares each driving efficiency read in the step S301 and thereby conducts the selection of the motor generators MG1, MG2 (step S302).

Then, it is determined whether the selected one is the first motor generator MG1 or not (step S303). When that is the first motor generator MG1, the speed-ratio setting device 53 of the PCM 50 sets the speed ratio having the highest driving efficiency for the first motor generator MG1 based on the demanded torque calculated in the step S12 in the main routine (step S304). Thereby, the transmission electromagnetic valve 18 is driven, so the speed ratio of the transmission 16 is properly changed according to the control executed in the step S302. Then, the clutch control device 54 of the PCM 50 connects the first clutch Ch1 and disconnects the second clutch Ch2 (step S305).

Meanwhile, when the answer of the determination of the step S303 is NO, that is, when the second motor generator MG2 is selected, the clutch control device 54 of the PCM 50 disconnects the first clutch Ch1 and connects the second clutch Ch2 (step S306).

After the steps S305, S306, the selected motor generator is driven (step S307), and the control returns to the main routine.

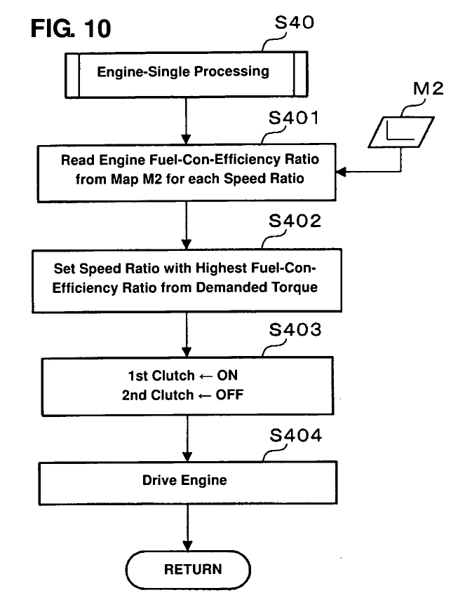

FIG. 10 is a flowchart of the driving processing subroutine for the engine-single operation (step S40) of FIG. 7.

Referring to FIG. 10, in the driving processing subroutine for the engine-single operation, the PCM 50 reads the fuel-consumption-efficiency ratio of the engine 10 for each speed ratio from the control map M2 of the graph of FIG. 4 (step S401). Then, the speed-ratio setting device 53 of the PCM 50 sets the speed ratio having the highest fuel-consumption-efficiency ratio based on the demanded torque calculated in the step S12 in the main routine (step S402). Thereby, the transmission electromagnetic valve 18 is driven, so the speed ratio of the transmission 16 is properly changed according to the control executed in the step S402.

Next, the clutch control device 54 of the PCM 50 connects the first clutch Ch1 and disconnects the second clutch Ch2 (step S403).

After this, the engine 10 is operated (step S404), and the control returns to the main routine.

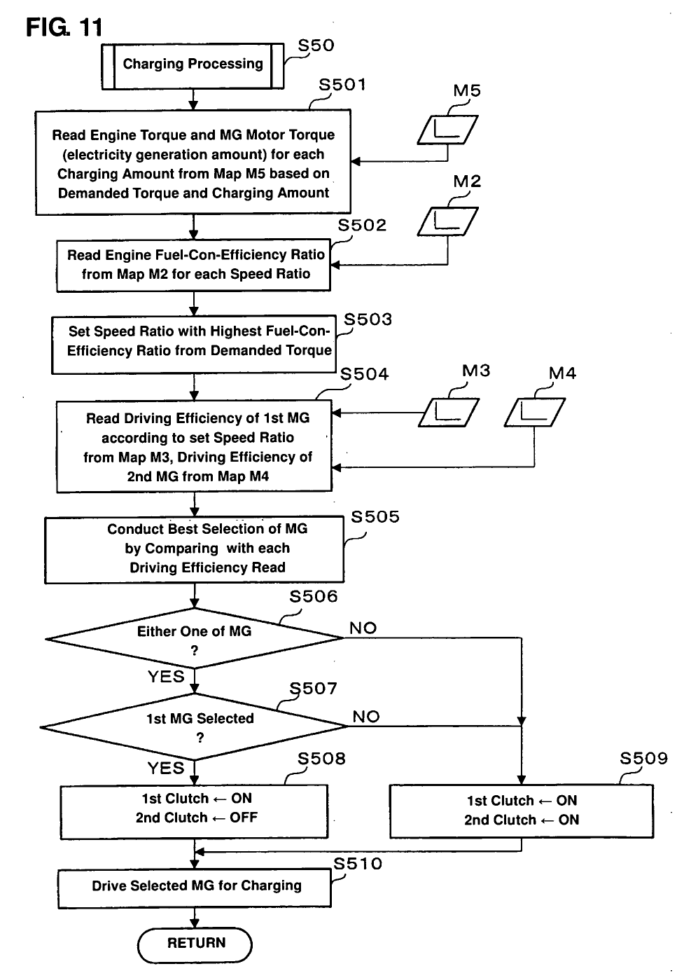

FIG. 11 is a flowchart of the charging processing subroutine (step S50) of FIG. 7.

Referring to FIG. 11, in the charging processing subroutine, the PCM 50 reads the engine torque and the motor torque (electricity generation amount) for each charging amount from the charging control map M5 related to the graph of FIG. 3, based on the demanded torque and the charging amount that are results of the steps S11, S12 of the main routine (step S501).

Then, the PCM 50 reads the fuel-consumption-efficiency ratio of the engine 10 for each speed ratio from the control map M2 (step S502). Next, the speed-ratio setting device 53 of the PCM 50 sets the speed ratio having the highest fuel-consumption-efficiency ratio (step S503). Thereby, the transmission electromagnetic valve 18 is driven, so the speed ratio of the transmission 16 is properly changed according to the control executed in the step S503.

Next, the PCM 50 reads the driving efficiency of the first motor generator MG1 according to each speed ratio set in the step S503, and reads the driving efficiency of the second motor generator MG2 from the control map M4 (step S504). The PCM 50 compares each driving efficiency read in the step S504 and thereby conducts the selection of the motor generators MG1, MG2 (step S505). Herein, the PCM 50 calculates the best combination efficiency based on the set speed ratio, and selects the motor generator. Thus, either one or both of the first and second motor generators MG1, MG2 are selected based on the driving state or the charging amount.

Next, the control of the first and second clutches Ch1, Ch2 are executed based on the selection manner of the first and second motor generators MG1, MG2.

First, the PCM 50 determines whether either one of the motor generators is selected or not (step S506). When either one of the first and second motor generators MG1, MG2 is selected, further determination as to whether the selected one is the first motor generator MG1 or not is conducted (step S507). When that is the first motor generator MG1, the clutch control device 54 of the PCM 50 connects the first clutch Ch1 and disconnects the second clutch Ch2 (step S508).

Meanwhile, when both the first and second motor generators MG1, MG2 are selected in the step S505, or when only the second motor generator MG2 is selected, the clutch control device 54 of the PCM 50 connects both the first and second clutches Ch1, Ch2 (step S509).

Then, the selected motor generator is operated as the driving source for the charging (step S510), and the control returns to the main routine.

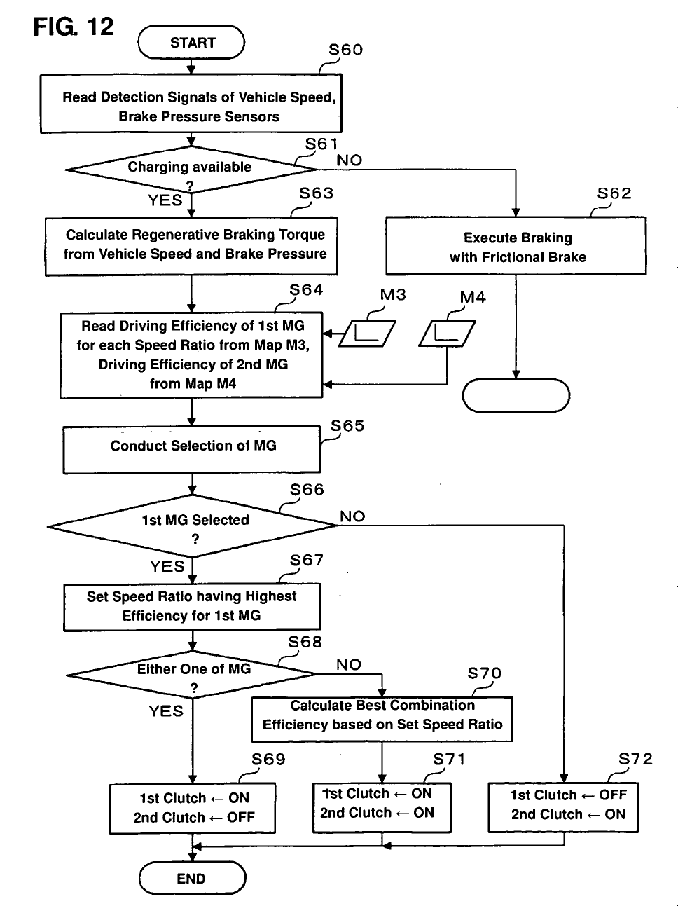

FIG. 12 is a flowchart of an example of regeneration processing according to the present embodiment.

Referring to FIG. 12, the present embodiment is configured so that when the vehicle deceleration of the hybrid vehicle 1 is demanded, the regeneration processing of braking and charging of the vehicle by using the first and second motor generators MG1, MG2 is executed under a specified driving state.

The PCM 50, in the regeneration processing, first reads the detection signals of the vehicle speed sensor SW2 and the brake pressure sensor SW4 (step S60) and determines availability of the regeneration processing.

Next, availability of charging is determined based on the detection signal of the battery sensor SW1 in order not to be overcharging of the battery (step S61). When the charging is not available, the brake control device 55 controls the brake control system 35 to execute the braking control with a frictional brake (step S62). Then, the control ends.

When the charging is available, the PCM 50 calculates a regenerative braking torque based on the vehicle speed and the brake pressure read in the step S60 (step S63). Then, the PCM 50 reads the driving efficiency of the first motor generator MG1 according to each speed ratio from the control map M3, and reads the driving efficiency of the second motor generator MG2 from the control map M4 (step S64). The PCM 50 compares each driving efficiency read in the step S64 and thereby conducts the selection of the motor generators MG1, MG2 (step S65).

Then, the control of the first and second clutches Ch1, Ch2 is conducted by the selection manner of the motor generators MG1, MG2.

In the regeneration processing, it is determined by the PCM 50 whether the selected one is the first motor generator MG1 or not (step S66). When that is the first motor generator MG1, the PCM 50 sets the speed ratio having the highest driving efficiency for the first motor generator MG1 (step S67). Thereby, the transmission electromagnetic valve 18 is driven, so the speed ratio of the transmission 16 is properly changed according to the control executed in the step S67.

Next, the PCM 50 determines whether only the first motor generator MG1 is selected or not (step S68).

When only the first motor generator MG1 is selected, the clutch control device 54 of the PCM 50 connects the first clutch Ch1 and disconnects the second clutch Ch2 (step S69). After this, the battery 34 is charged by the first motor generator MG1 with the braking of the engine 10.

Meanwhile, when the second motor generator MG2 is also selected in the step S68, the PCM 50 calculates the best combination efficiency based on the set speed ratio of the first motor generator (step S70). Then, the clutch control device 54 of the PCM 50 connects both the first and second clutches Ch1, Ch2 (step S71). Thereby, the battery 34 is charged by both the motor generators MG1, MG2.

Further, when the selected motor generator in the step S66 is only the second motor generator MG2, the clutch control device 54 of the PCM 50 disconnects the first clutch Ch1 and disconnects the second clutch Ch2 (step S72). Thereby, the battery 34 is charged by the second motor generator MG2 with the braking of the engine 10.

According to the above-described present embodiment, since the first and second motor generators MG1, MG2 having different high-efficiency driving operation areas are applied and any of the driving sources of the engine 10 and the respective motor generators MG1, MG2 are selected by the driving-source selection device 52 so as to provide the highest driving efficiency as a whole of the hybrid vehicle 1, the appropriate selection of the driving source can be provided in accordance with the vehicle driving states, thereby improving the driving efficiency as a whole of the hybrid vehicle 1. Herein, in the first motor generator MG1 directly coupled to the engine 10 for the engine cranking, its rotational speed may be generally influenced (restricted) by the rotational speed of the engine shaft during the electricity generation or torque assist. Since the rotational speed of the engine shaft does not lower below an idling speed while the engine operates, the first motor generator MG1 operates at a relatively higher-speed driving area relative to the second motor generator MG2. According to the present embodiment, since the first and second motor generators MG1, MG2 are further configured so that the high-efficiency driving operation area of the first motor generator MG1 is set on the higher-speed side relative to the high-efficiency driving operation area of the second motor generator MG2, the driving efficiency as a whole of the vehicle can be improved further properly, so that the properly efficient electricity generation or torque assist can be provided.

Also, according to the present embodiment, the engine 10 and the first motor generator MG1 are coupled to the differential mechanism 20 of the hybrid vehicle 1 via the transmission 16, and the driving-source selection device 52 is configured so as to determine the driving efficiency of the first motor generator MG1 and compare that with the driving efficiency of the second motor generator MG2 for each speed ratio of the transmission 16. Thereby, the first motor generator MG1 can be used as the driving source for the middle-high speed in which the driving efficiency increases in proportion to the rotational speed of the engine 10, and comparison with the driving efficiency of the second motor generator MG2 can be conducted by determining the high-efficiency operation area that is changeable for each speed ratio. Accordingly, the more accurate appropriate distribution can be attained.

Further, according to the present embodiment, the control device further comprises the speed-ratio setting device 53 operative to set the speed ratio of the transmission 16 at the specified speed ratio that enables the first motor generator MG1 to provide the highest driving efficiency when the driving-source selection device 52 selects the first motor generator MG1 as the driving source without the operation of the engine 10. Thereby, since the speed ratio is set so as to provide the highest driving efficiency of the first motor generator MG1 when the engine 10 is not operated, the driving efficiency as a whole of the hybrid vehicle 1 can be further improved.

Also, according to the present embodiment, the speed-ratio setting device 53 is configured to set the speed ratio of the transmission 16 at the specified speed ratio that enables the fuel-consumption efficiency of the engine 10 to provide the highest efficiency when the driving-source selection device 52 selects the engine 10 and the first motor generator MG1 as the driving source. Thereby, the fuel-consumption efficiency of the engine 10 has priority in the driving area where the engine operation is needed. Herein, the meaning of “when the driving-source selection device selects 52 the engine 10 and the first motor generator MG1 as the driving source” includes a case where the engine 10 and both of the first and second motor generators MG1, MG2 are selected by the driving-source selection device 52 as the execution of the driving processing subroutine for the engine-joint operation shown in FIG. 8.

Further, according to the present embodiment, the motor output shaft 32 of the second motor generator MG2 is coupled to the output shaft 19 of the transmission 16, the first clutch Ch1 is provided between the first motor generator MG1 and the transmission 16, the second clutch Ch2 is provided at the motor output shaft 32 of the second motor generator MG2, and there is provided the clutch control device 54 operative to control the first and second clutches Ch1, Ch2 so as to disconnect the first clutch Ch1 when the driving-source selection device 52 selects only the second motor generator MG2 as the driving source (without the operation of the engine 10) and to disconnect the second clutch Ch2 when the driving-source selection device 52 excludes the second motor generator GM2 from the driving source. Thereby, in the driving area where only the second motor generator MG2 is operated (at the low-speed vehicle starting, or the reverse vehicle driving, mainly), the driving torque of the second motor generator MG2 can be transmitted to the vehicle driving shaft 21 without receiving any resistance of the engine 10 or the first motor generator MG1. Further, in the driving area where the second motor generator MG2 is not operated (at the middle-high speed driving, mainly), the driving torque of the engine 10 or the first motor generator MG1 can be transmitted to the vehicle driving shaft wheel 21 without receiving any resistance of the second motor generator MG2. Accordingly, the driving efficiency as a whole of the hybrid vehicle 10 can be improved.

### Embodiment 2

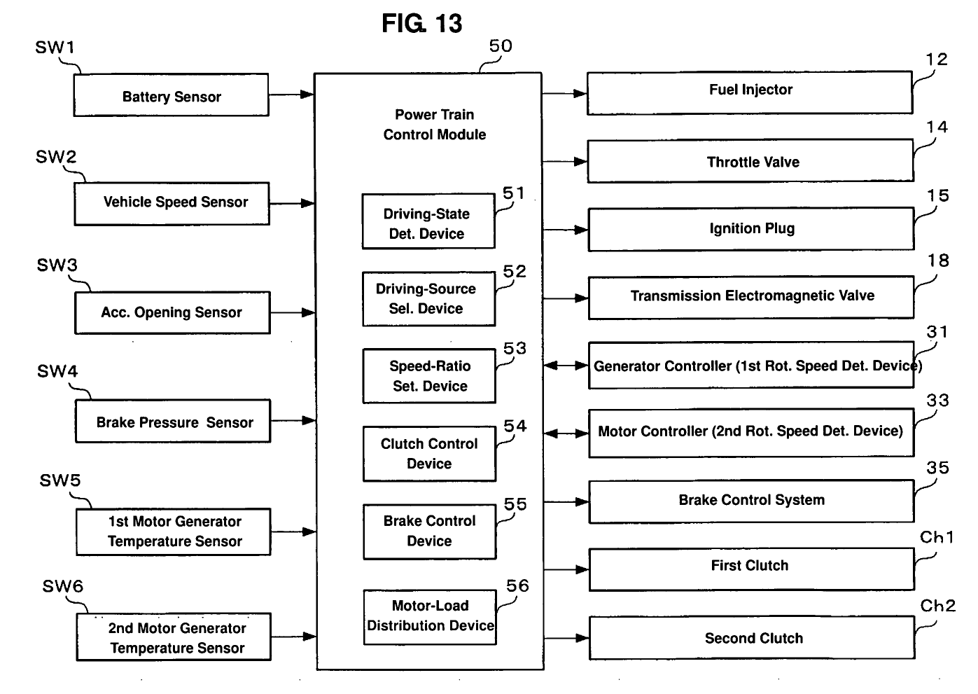

Hereinafter, a second embodiment will be described referring to FIGS. 13 through 29. The same components as those of the first embodiment are denoted by the same reference characters, detailed descriptions of which are omitted here.

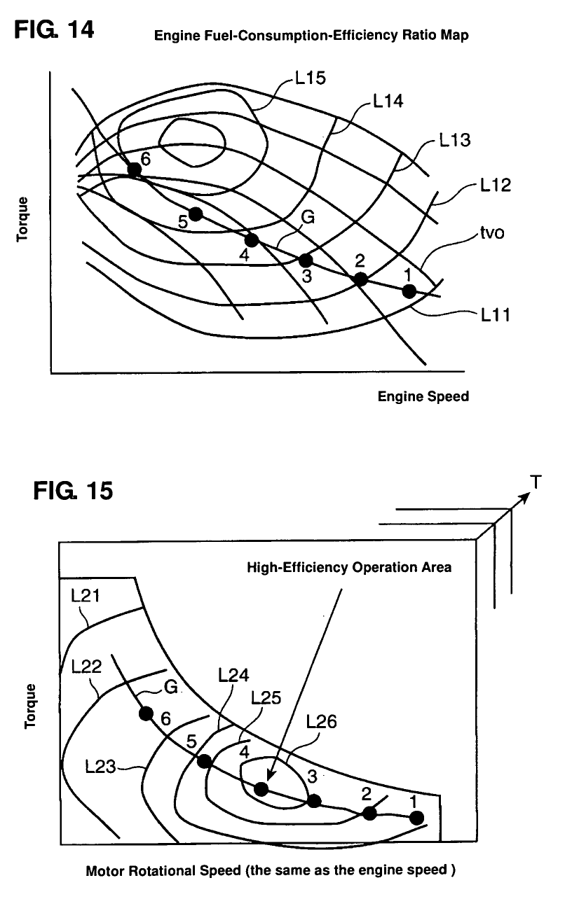

According to the second embodiment, a control map M10 and a control map M11 based on graphs of FIGS. 14 and 15 are provided for the section of the motor generators MG1, MG2.

FIG. 14 is a graph of the engine fuel-consumption-efficiency ratio map based on the torque and the engine speed, which is substantially the same as FIG. 4 in the first embodiment.

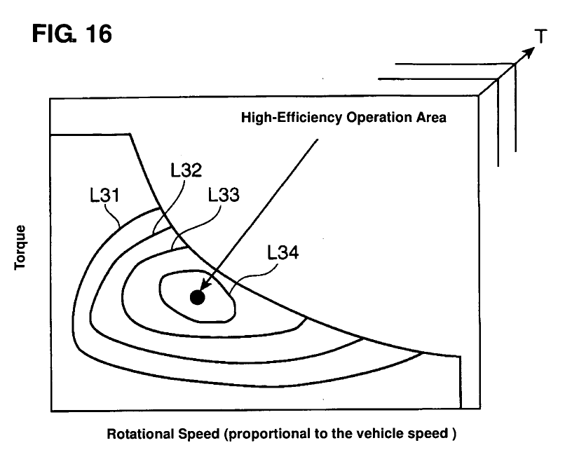

Next, the high-efficiency operation area of the first and second motor generators MG1, MG2 will be described. Herein, “high-efficiency operation area” means a driving area where the efficiency is the highest in the characteristics map based on the torque and the engine speed. This high-efficiency operation area is selected as the highest-efficiency area in the graph shown in FIGS. 15 and 16.

FIG. 15 is a graph showing the driving-efficiency operation area of the first motor generator based on the torque and the motor rotational speed according to the second embodiment.

Referring to FIG. 15, in this graph, plural areas based on the torque and the motor speed as the driving efficiency ratio of the first motor generator MG1 are set by plural contour lines L21-L26. According to the second embodiment, the combination of the torque and the motor speed is memorized in the memory as the control map M11 based on this graph, and the comparison with the data of a control map M12, which will be described below, enables determination of the necessity of operation of each of the first and second motor generators MG1, MG2. Herein, the first motor generator MG1 is directly coupled to the crank shaft 11, so the high-efficiency operation area (inside the contour line L26) is set in the middle-speed and low-load area. Also, since the first motor generator MG1 is directly coupled to the crank shaft 11, the driving efficiency of the first motor generator MG1 differs depending on the speed ratio of the transmission 16 even at the same torque and motor rotational speed. Therefore, a speed ratio graph G (figures in the graph indicate the speed ratio) is set in the control map M11 as shown in FIG. 15 so as to specify the driving efficiency of the first motor generator MG1 for each speed ratio.

FIG. 16 is a graph showing the driving-efficiency operation area of the second motor generator based on the torque and the motor rotational speed according to the second embodiment.

Referring to FIG. 16, in this graph, plural areas based on the torque and the motor speed as the driving efficiency ratio of the second motor generator MG2 are set by plural contour lines L31-L34. According to the present embodiment, the combination of the torque and the motor speed is memorized in the memory as the control map M12 based on this graph, and the comparison with the data of the control map M11 shown in FIG. 15 enables determination of the necessity of operation of each of the first and second motor generators MG1, MG2. Herein, the second motor generator MG2 is operated mainly at the vehicle starting, the reverse vehicle driving, or the light-load driving area, so the high-efficiency operation area (inside the contour line L34) is set at the low-speed and middle-load area.

Herein, the control maps M11, M12 of the second embodiment are comprised of a multi-dimension map including a temperature axis T so that the torque determined based on the rotational speed is changeable for each temperature at the vehicle driving in light of changing of the driving efficiency of the motor generators MG1, MG2 according to the temperature.

The speed-ratio setting device 53 is configured to select, based on the control maps M10, M11, either one of the speed ratio that is determined by the fuel-consumption-efficiency ratio of the engine 10 and the speed ratio that is determined by the efficiency operation area of the first motor generator MG1 in accordance with the driving state. As shown in FIGS. 14 and 15, the speed ratio graph G is set in the control maps M10, M11 so as to specify the fuel-consumption-efficiency ratio of the engine 10 and the driving efficiency of the first motor generator MG1 for each speed ratio. Herein, according to the second embodiment, the speed-ratio setting device 53 is configured so that the speed ratio to provide the highest fuel-consumption-efficiency ratio (fuel economy) of the engine 10 is selected with priority in a case where the engine 10 and the first motor generator MG1 are used at the same time as the driving source as shown in the flowcharts described below. As a result, in the driving area where the engine 10 and the first motor generator MG1 are used at the same time as the driving source, the hybrid vehicle 1 is operated in the state where the fuel-consumption-efficiency ratio (fuel economy) becomes the highest.

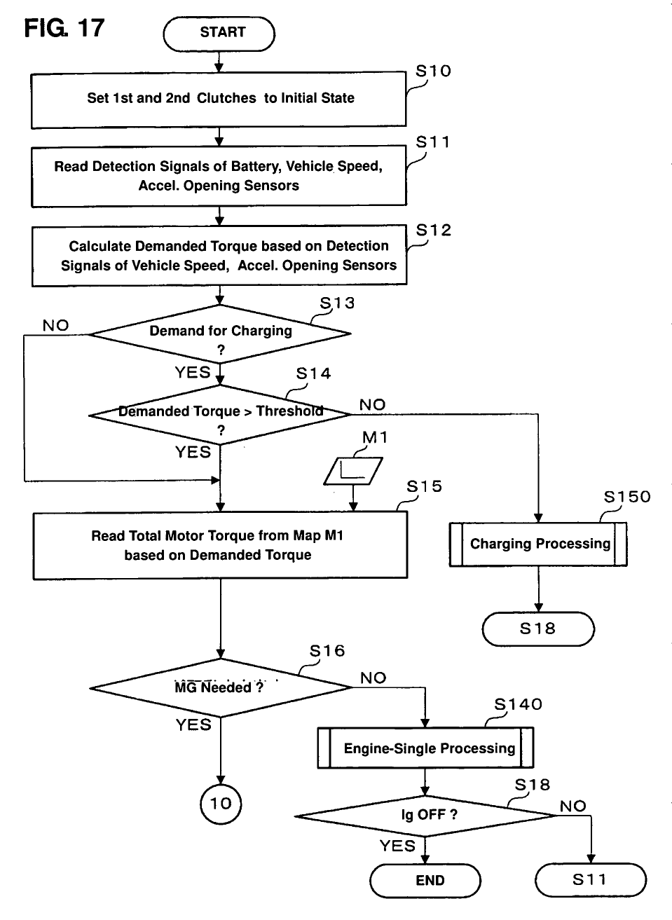

Next, an exemplified driving control of the hybrid vehicle according to the second embodiment will be described referring to FIGS. 17-29.

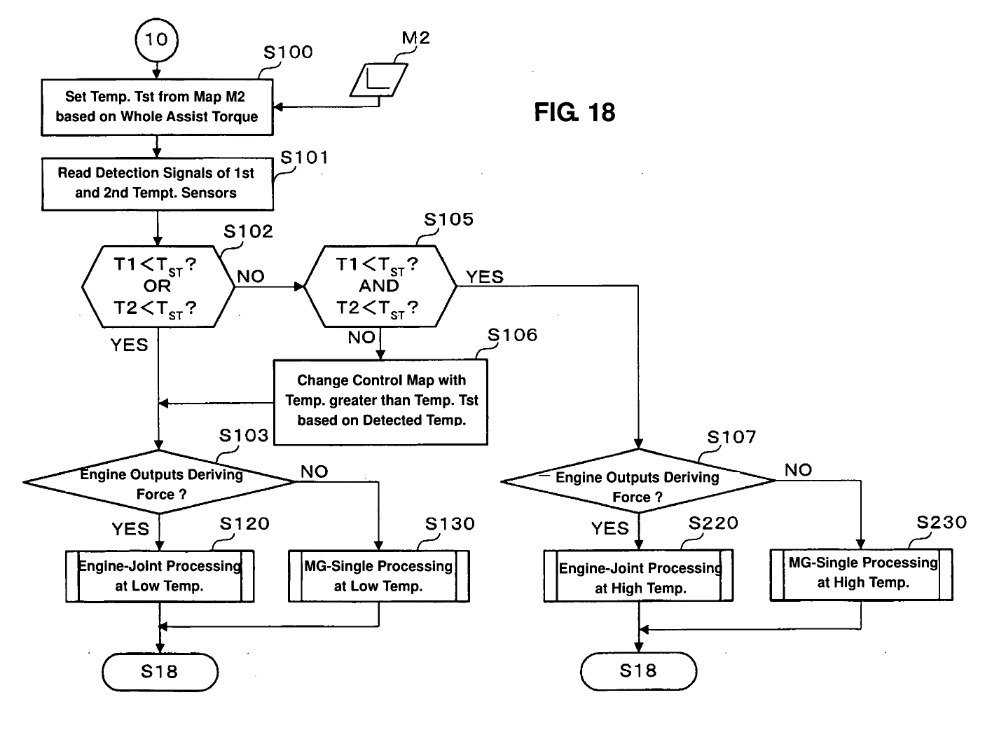

FIGS. 17 and 18 are flowcharts showing the exemplified driving control of the hybrid vehicle according to the second embodiment of the present invention.

Referring to FIG. 17, this flowchart is executed by the PCM 50 when the ignition switch of the hybrid vehicle 1 is turned on.

When the ignition switch is turned on, the PCM 50 executes the processing of the steps S10-S16 like the first embodiment.

When it is determined that the demanded torque exceeds the specified threshold in the step S14, the charging processing subroutine (step S150), which will be described below, is executed, and the control proceeds to the step S18.

When it is determined that any one of the first and second motor generators MG1, MG2 needs to be operated in the step S16, the PCM 50 proceeds to a flowchart shown in FIG. 18.

Meanwhile, when it is determined that none of the first and second motor generators MG1, MG2 needs to be operated, the driving processing subroutine for the engine-single operation (step S140) is executed.

After the driving processing subroutine for the engine-single operation (step S140), the PCM 50 determines whether the ignition switch is turned OFF or not (step S18). When it is determined that it is turned OFF, the processing ends. When it is determined that it is not turned OFF yet, the control proceeds to the step S11 and repeats the above-described processing.

Next, referring to FIG. 18, at the driving area where any one of the motor generators MG1, MG2 is operated, a specified temperature Tₛₜ is set from the control map M2 based on the whole assist torque (step S100). Next, the detection signals of the first and second temperature sensors SW5, SW6 are read (step S101), and it is determined whether any one of the detected temperatures T1, T2 of the motor generators MG1, MG2 is less than the specified temperature Tₛₜ or not (step S102). When both the temperatures T1, T2 of the motor generators MG1, MG2 is less than the specified temperature Tₛₜ, the PCM 50 determines whether the current driving area is the area where the engine 10 outputs its driving force (step S103). When it is determined that the current driving area is the one where the engine 10 outputs its driving force, the PCM 50 executes a driving processing subroutine for an engine-joint operation at a low temperature (step S120). When it is determined that the current driving area is not the one where the engine 10 outputs its driving force, the PCM 50 executes a driving processing subroutine for a motor-generator-single operation at a low temperature (step S130), and then proceeds to the step S18.

When it is determined that any one of the detected temperatures T1, T2 of the motor generators MG1, MG2 is the specified temperature Tₛₜ or greater in the step S102, the PCM 50 determines whether or not both the temperatures T1, T2 of the motor generators MG1, MG2 are the specified temperature Tₛₜ or greater (step S105).

When it is determined that any one of the detected temperatures T1, T2 of the motor generators MG1, MG2 is less than the specified temperature Tₛₜ in the step S105, a motor-load distribution device 56 of the PCM 50 changes the control map (M11 or M12) with the temperature greater than the specified temperature Tₛₜ based on the detected temperature (step S106). This setting change of the control map (sifting of coordinates of the temperature axis T) can recognize that the above-described motor generator with the high temperature is inferior in efficiency, and thus the rate of operation of this motor generator will reduce.

When it is determined that both the detected temperatures T1, T2 of the motor generators MG1, MG2 are the specified temperature Tₛₜ or greater in the step S105, the PCM 50 determines whether the current driving area is the area where the engine 10 outputs its driving force or not (step S107). When it is determined that the current driving area is the one where the engine 10 outputs its driving force, the PCM 50 executes a driving processing subroutine for an engine-joint operation at a high temperature (step S220). When it is determined that the current driving area is not the one where the engine 10 outputs its driving force, the PCM 50 executes a driving processing subroutine for a motor-generator-single operation at a high temperature (step S230), and then proceeds to the step S18.

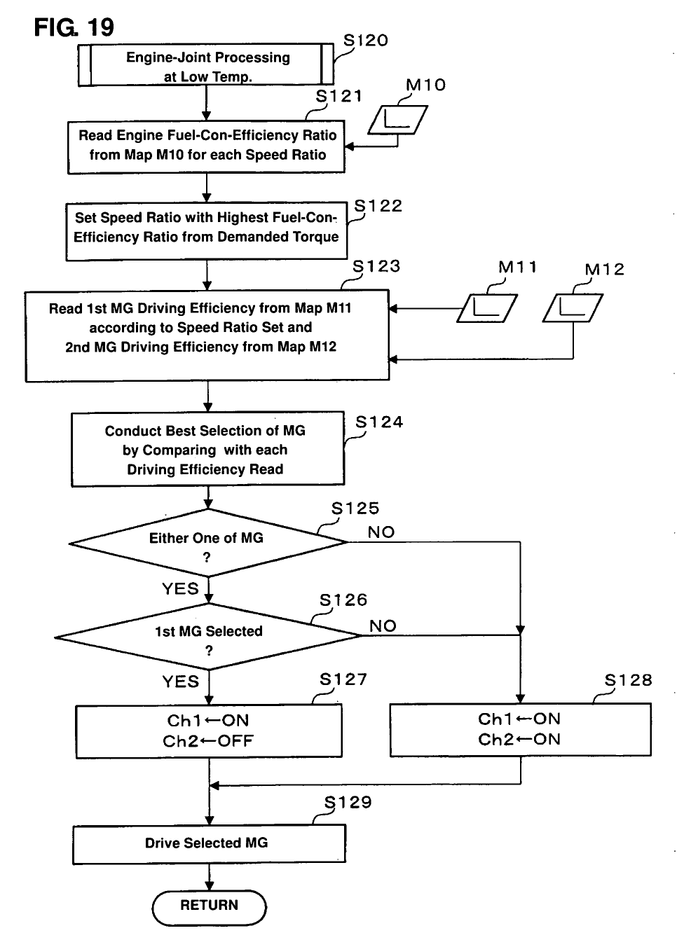

FIG. 19 is a flowchart of the driving processing subroutine for the engine-joint operation at the low temperature (step S120) of FIG. 17.

Referring to FIG. 19, in the driving processing subroutine for the engine-joint operation at the low temperature, the PCM 50 reads the fuel-consumption-efficiency ratio of the engine 10 from the control map M10 of the graph of FIG. 14 for each speed ratio (step S121). Then, the speed-ratio setting device 53 of the PCM 50 sets the speed ratio having the highest fuel-consumption-efficiency ratio based on the demanded torque calculated in the step S12 in the main routine (step S122). Thereby, the transmission electromagnetic valve 18 is driven, so the speed ratio of the transmission 16 is properly changed according to the control executed in the step S122.

Next, the PCM 50 reads the driving efficiency of the first motor generator MG1 according to the speed ratio set in the step S122 based on the control map M11 of the graph of FIG. 15 and also reads the driving efficiency of the second motor generator MG2 from the control map M12 of the graph of FIG. 16 (step S123). The PCM 50 conducts the selection of the motor generators MG1, MG2 by comparing with each driving efficiency read in the step S123 (step S124).

Herein, the PCM 50 calculates the best combined driving efficiency based on the speed ratio set and then selects the motor generator. The “combined driving efficiency” means the driving efficiency that is obtained by distributing the driving efficiency of the first motor generator MG1 corresponding to the selected speed ratio and the driving efficiency of the second motor generator MG2 corresponding to the selected speed according to a specified calculation equation in an optimization method, such as a simplex method. Thus, either one or both of the first and second motor generators MG1, MG2 are selected based on the driving state or the charging amount.

Next, the control of the first and second clutches Ch1, Ch2 are executed based on the selection manner of the first and second motor generators MG1, MG2.

Specifically, the PCM 50 determines whether either one of the motor generators is selected or not (step S125). When either one of the first and second motor generators MG1, MG2 is selected, further determination as to whether the selected one is the first motor generator MG1 or not is conducted (step S126). When that is the first motor generator MG1, the clutch control device 54 of the PCM 50 connects the first clutch Ch1 and disconnects the second clutch Ch2 (step S127).

Meanwhile, when both the first and second motor generators MG1, MG2 are selected in the step S125, or when only the second motor generator MG2 is selected in step S126, the clutch control device 54 of the PCM 50 connects both the first and second clutches Ch1, Ch2 (step S128).

Then, the selected motor generator is driven (step S129), and the control returns to the main routine.

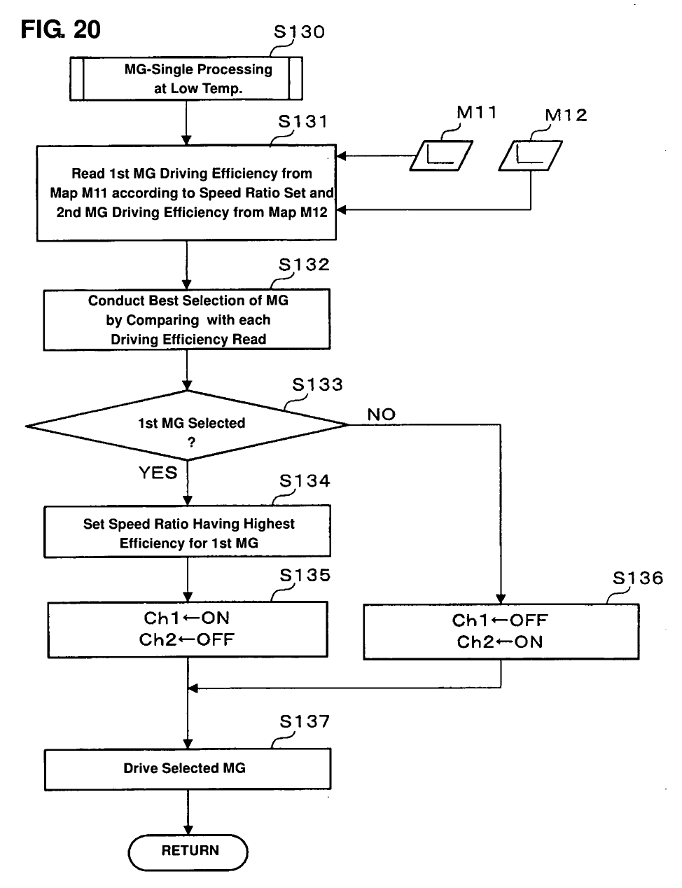

FIG. 20 is a flowchart of the driving processing subroutine for the motor-single operation at the low temperature (step S130) of FIG. 17.

Referring to FIG. 20, in the driving processing subroutine for the motor-single operation at the low temperature, the PCM 50 reads the driving efficiency of the first motor generator MG1 according to each speed ratio from the control map M11 of the graph of FIG. 15, and reads the driving efficiency of the second motor generator MG2 from the control map M12 of the graph of FIG. 16 (step S131). The PCM 50 compares each driving efficiency read in the step S131 and thereby conducts the selection of the motor generators MG1, MG2 (step S132).

Then, it is determined whether the selected one is the first motor generator MG1 or not (step S133). When that is the first motor generator MG1, the speed-ratio setting device 53 of the PCM 50 sets the speed ratio having the highest driving efficiency for the first motor generator MG1 based on the demanded torque calculated in the step S12 in the main routine (step S134). Thereby, the transmission electromagnetic valve 18 is driven, so the speed ratio of the transmission 16 is properly changed according to the control executed in the step S132. Then, the clutch control device 54 of the PCM 50 connects the first clutch Ch1 and disconnects the second clutch Ch2 (step S135).

Meanwhile, when the answer of the determination of the step S133 is NO, that is, when the second motor generator MG2 is selected, the clutch control device 54 of the PCM 50 disconnects the first clutch Ch1 and connects the second clutch Ch2 (step S136).

After the steps S135, S136, the selected motor generator is driven (step S137), and the control returns to the main routine.

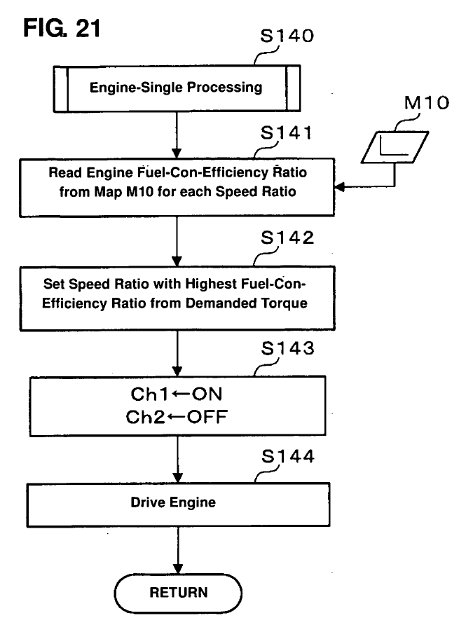

FIG. 21 is a flowchart of the driving processing subroutine for the engine-single operation (step S140) of FIG. 17.

Referring to FIG. 21, in the driving processing subroutine for the engine-single operation, the PCM 50 reads the fuel-consumption-efficiency ratio of the engine 10 for each speed ratio from the control map M10 of the graph of FIG. 14 (step S141).

Then, the speed-ratio setting device 53 of the PCM 50 sets the speed ratio having the highest fuel-consumption-efficiency ratio based on the demanded torque calculated in the step S12 in the main routine (step S142). Thereby, the transmission electromagnetic valve 18 is driven, so the speed ratio of the transmission 16 is properly changed according to the control executed in the step S142.

Next, the clutch control device 54 of the PCM 50 connects the first clutch Ch1 and disconnects the second clutch Ch2 (step S143).

After this, the engine 10 is driven (step S144), and the control returns to the main routine.

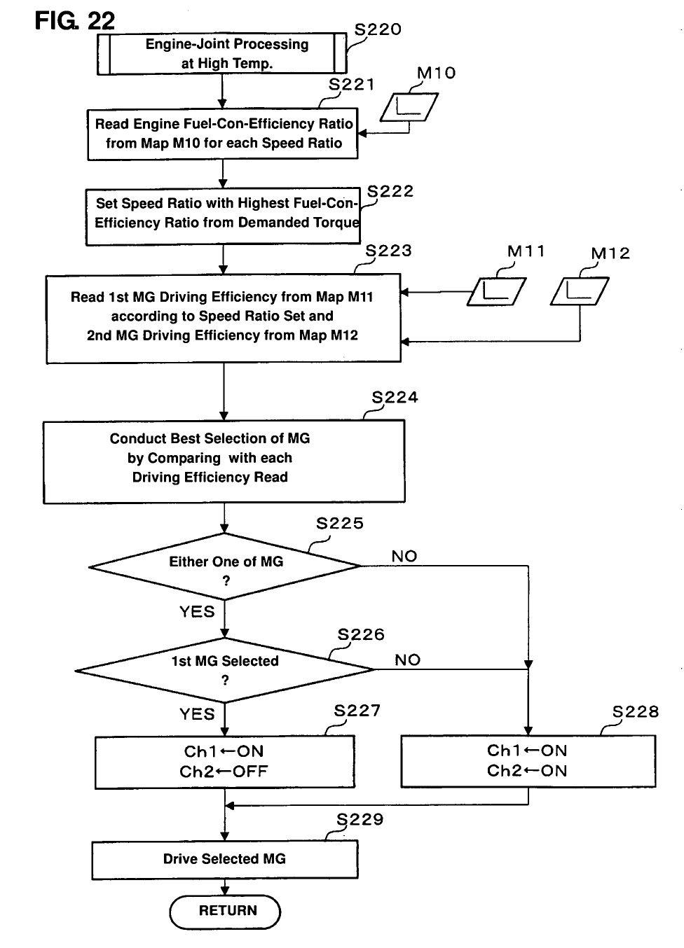

FIG. 22 is a flowchart of the charging processing subroutine at the high temperature (step S220) of FIG. 17.

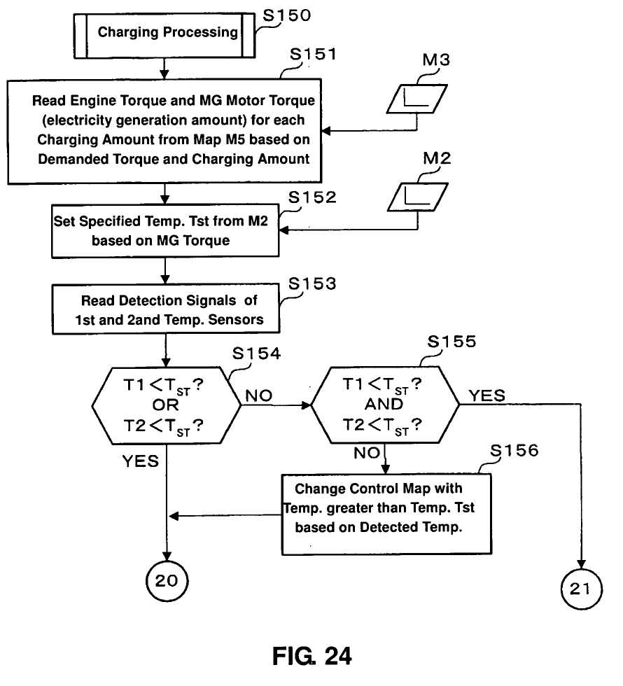

Referring to FIG. 22, in the charging processing subroutine at the high temperature, the PCM 50 reads the engine torque and the motor torque (electricity generation amount) for each charging amount from the charging control map M10 related to the graph of FIG. 24 (step S221). Next, the speed-ratio setting device 53 of the PCM 50 sets the speed ratio having the highest fuel-consumption-efficiency ratio based on the demanded torque calculated in the step S22 of the main routine (step S222). Thereby, the transmission electromagnetic valve 18 is driven, so the speed ratio of the transmission 16 is properly changed according to the control executed in the step S222.

Next, the PCM 50 reads the driving efficiency of the first motor generator MG1 according to each speed ratio set in the step S222 from the control map M11 of the graph of FIG. 15, and reads the driving efficiency of the second motor generator MG2 from the control map M12 of the graph of FIG. 16 (step S223). The PCM 50 calculates the best combination efficiency based on the set speed ratio based on the torques read in this step S223 and selects the motor generator (step S224). This selection is executed by distributing the rotational speed for the demanded torque of the first motor generator MG1 and the rotational speed for the demanded torque of the second motor generator MG2 according to a specified calculation equation in an optimization method, such as the simplex method. Thus, either one or both of the first and second motor generators MG1, MG2 are selected based on the rotational speed through these steps. Thereby, even if both the motor generators MG1, MG2 have the higher temperature and the current driving area is the one where at least one of the motor generators MG1, MG2 needs to be operated, the drop of the driving efficiency can be prevented as much as possible and thus the necessary amount of torque can be maintained.

Next, the control of the first and second clutches Ch1, Ch2 are executed based on the selection manner of the first and second motor generators MG1, MG2.

First, the PCM 50 determines whether either one of the motor generators is selected or not (step S225). When either one of the first and second motor generators MG1, MG2 is selected, further determination as to whether the selected one is the first motor generator MG1 or not is conducted (step S226). When that is the first motor generator MG1, the clutch control device 54 of the PCM 50 connects the first clutch Ch1 and disconnects the second clutch Ch2 (step S227).

Meanwhile, when both the first and second motor generators MG1, MG2 are selected in the step S225, or when only the second motor generator MG2 is selected in the step S226, the clutch control device 54 of the PCM 50 connects both the first and second clutches Ch1, Ch2 (step S228).

Then, the selected motor generator is operated as the driving source (step S229), and the control returns to the main routine.

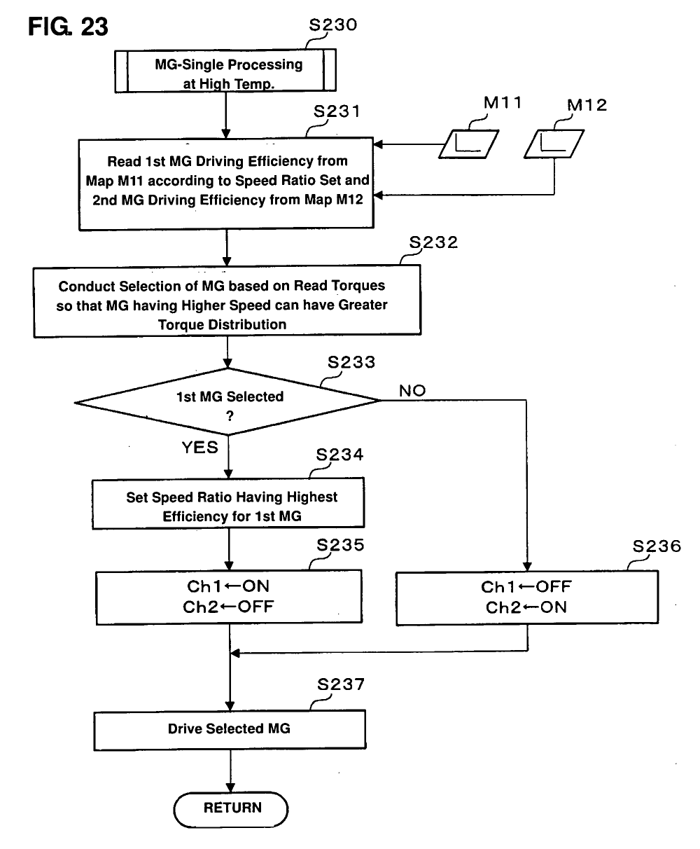

FIG. 23 is a flowchart of the driving processing subroutine for the motor-single operation at the high temperature (step S230) of FIG. 17.

Referring to FIG. 23, in the driving processing subroutine for the motor-single operation at the high temperature, the PCM 50 reads the driving efficiency of the first motor generator MG1 according to each speed ratio from the control map M11 of the graph of FIG. 15, and reads the driving efficiency of the second motor generator MG2 from the control map M12 of the graph of FIG. 16 (step S231). The motor-load distribution device 56 of the PCM 50 conducts the selection of the motor generators MG1, MG2 based on the respective torques read in this step S231 so that the motor generator having the higher rotational speed can have the greater torque distribution (step S232). Thereby, even if the current driving area is the one where both the motor generators MG1, MG2 have the high temperature, the load distribution rate of the motor generator having the higher driving efficiency is increased (in other words, the load distribution rate of the motor generator having the lower driving efficiency is reduced), so the drop of the driving efficiency can be prevented as much as possible and thus the necessary amount of torque can be maintained.

Then, it is determined whether the selected one is the first motor generator MG1 or not (step S233). When that is the first motor generator MG1, the speed-ratio setting device 53 of the PCM 50 sets the speed ratio having the highest driving efficiency for the first motor generator MG1 (step S234). Thereby, the transmission electromagnetic valve 18 is driven, so the speed ratio of the transmission 16 is properly changed according to the control executed in the step S232. Then, the clutch control device 54 of the PCM 50 connects the first clutch Ch1 and disconnects the second clutch Ch2 (step S235).

Meanwhile, when the answer of the determination of the step S233 is NO, that is, when the second motor generator MG2 is selected, the clutch control device 54 of the PCM 50 disconnects the first clutch Ch1 and connects the second clutch Ch2 (step S236).

After the steps S235, S236, the selected motor generator is driven (step S237), and the control returns to the main routine.

FIGS. 24-26 are flowcharts of the charging processing subroutine (step S150) of FIG. 17.

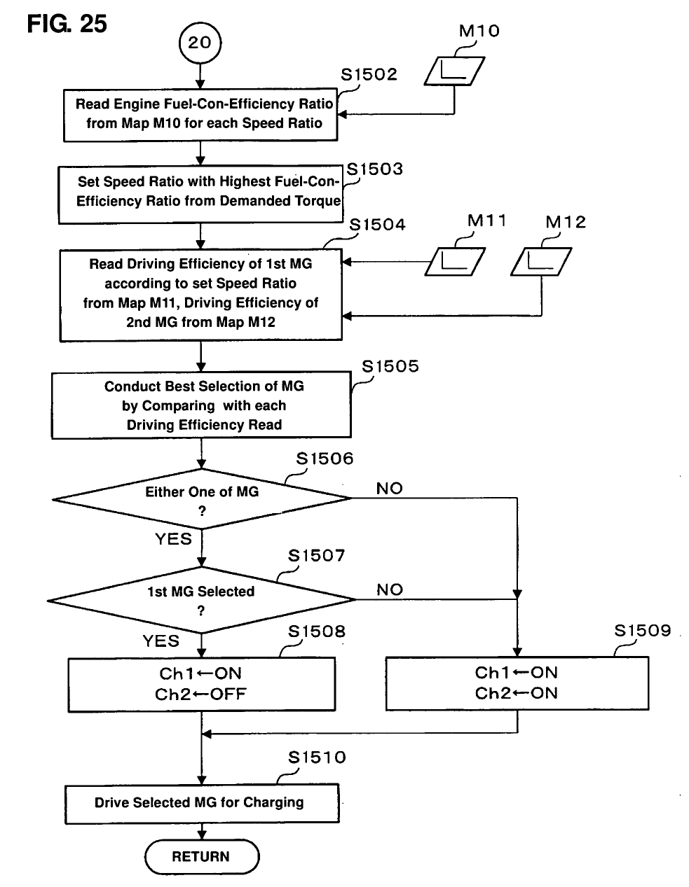

Referring to FIG. 24, in the charging processing subroutine, the PCM 50 reads the engine torque and the motor torque (electricity generation amount) for each charging amount from the charging control map M5, based on the demanded torque and the charging amount that are results of the steps S11, S12 of the main routine (step S151). Next, the PCM 50 sets the specified temperature Tₛₜ from the control map M2 based on the whole assist torque (step S152). Next, the detection signals of the first and second temperature sensors SW5, SW6 are read (step S153), and it is determined whether any one of the detected temperatures T1, T2 of the motor generators MG1, MG2 is less than the specified temperature Tₛₜ or not (step S154). When both the temperatures T1, T2 of the motor generators MG1, MG2 is less than the specified temperature Tₛₜ, the PCM 50 executes processing shown in FIG. 25.

When it is determined that any one of the detected temperatures T1, T2 of the motor generators MG1, MG2 is the specified temperature Tₛₜ or greater in the step S154, the PCM 50 determines whether or not both the temperatures T1, T2 of the motor generators MG1, MG2 are the specified temperature Tₛₜ or greater (step S155).

When it is determined that any one of the detected temperatures T1, T2 of the motor generators MG1, MG2 is less than the specified temperature Tₛₜ in the step S155, the motor-load distribution device 56 of the PCM 50 changes the control map (M11 or M12) with the temperature greater than the specified temperature Tₛₜ based on the detected temperature (step S156). This setting change of the control map can recognize that the above-described motor generator with the high temperature is inferior in efficiency, and thus the rate of operation of this motor generator will reduces.

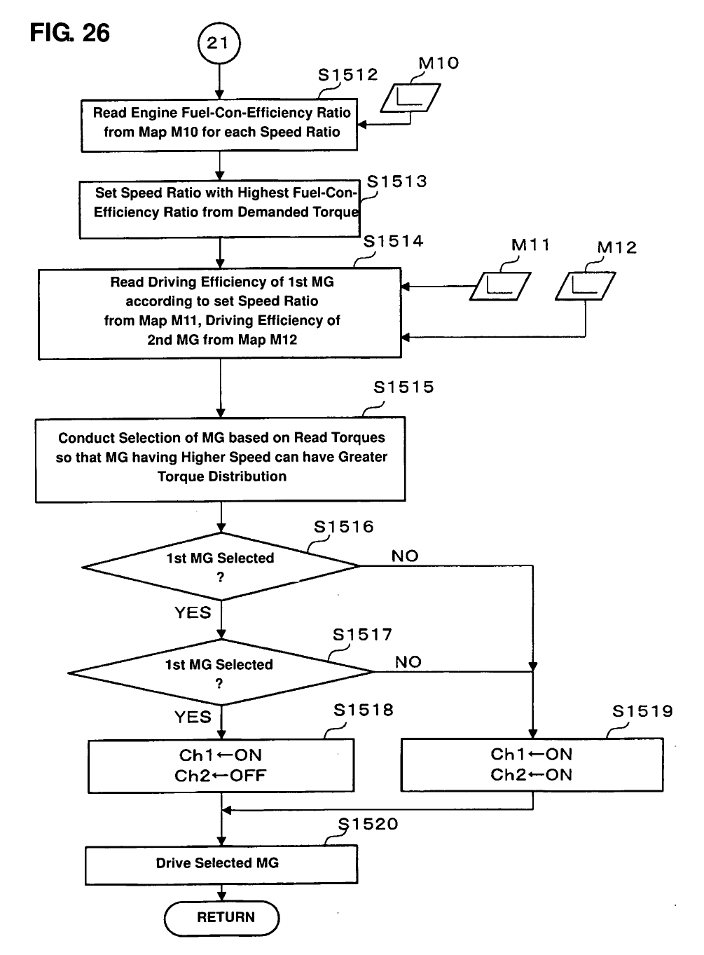

When it is determined that both the detected temperatures T1, T2 of the motor generators MG1, MG2 are the specified temperature Tₛₜ or greater in the step S155, the PCM 50 executes the processing shown in FIG. 26.

Referring to FIG. 25, when it is determined that any one of the detected temperatures T1, T2 of the motor generators MG1, MG2 is less than the specified temperature Tₛₜ in the step S154 of FIG. 24, the PCM 50 reads the fuel-consumption-efficiency ratio of the engine 10 for each speed ratio from the control map M10 (step S1502). Next, the speed-ratio setting device 53 of the PCM 50 sets the speed ratio having the highest fuel-consumption-efficiency ratio (step S1503). Thereby, the transmission electromagnetic valve 18 is driven, so the speed ratio of the transmission 16 is properly changed according to the control executed in the step S1503.

Next, the PCM 50 reads the driving efficiency of the first motor generator MG1 according to each speed ratio set in the step S1503 from the control map M11, and reads the driving efficiency of the second motor generator MG2 from the control map M12 (step S1504). The PCM 50 compares each driving efficiency read in the step S1504 and thereby conducts the selection of the motor generators MG1, MG2 (step S1505). Herein, the PCM 50 calculates the best combination efficiency based on the set speed ratio, and selects the motor generator. Thus, either one or both of the first and second motor generators MG1, MG2 are selected based on the driving state or the charging amount. Herein, since the control map of the motor generator having the temperature of Tₛₜ or greater is changed to the map having the lower driving efficiency in the step S156 of FIG. 24, the selection of the motor generators or the load distribution are executed in the step S1505 so that the load of the motor generator having the higher driving efficiency increases.

Next, the control of the first and second clutches Ch1, Ch2 are executed based on the selection manner of the first and second motor generators MG1, MG2.

First, the PCM 50 determines whether either one of the motor generators is selected or not (step S1506). When either one of the first and second motor generators MG1, MG2 is selected, further determination as to whether the selected one is the first motor generator MG1 or not is conducted (step S1507). When that is the first motor generator MG1, the clutch control device 54 of the PCM 50 connects the first clutch Ch1 and disconnects the second clutch Ch2 (step S1508).

Meanwhile, when both the first and second motor generators MG1, MG2 are selected in the step S1505, or when only the second motor generator MG2 is selected in the step S1507, the clutch control device 54 of the PCM 50 connects both the first and second clutches Ch1, Ch2 (step S1509).

Then, the selected motor generator is operated as the driving source for the charging (step S1510), and the control returns to the main routine.

Referring to FIG. 26, when it is determined that both the detected temperatures T1, T2 of the motor generators MG1, MG2 is the specified temperature Tₛₜ or greater in the step S155 of FIG. 24, the PCM 50 reads the fuel-consumption-efficiency ratio of the engine 10 for each speed ratio from the control map M10 (step S1512). Next, the speed-ratio setting device 53 of the PCM 50 sets the speed ratio having the highest fuel-consumption-efficiency ratio (step S1513). Thereby, the transmission electromagnetic valve 18 is driven, so the speed ratio of the transmission 16 is properly changed according to the control executed in the step S1503.

Next, the PCM 50 reads the torque of the first motor generator MG1 according to each speed ratio set in the step S1513 from the control map M11, and reads the torque of the second motor generator MG2 from the control map M12 (step S1514). The motor-load distribution device 56 of the PCM 50 conducts the selection of the motor generators MG1, MG2 based on the respective torques read in this step S1514 for each speed ratio so that the motor generator having the higher rotational speed can have the greater torque distribution (step S1515). Thereby, either one or both of the first and second motor generators MG1, MG2 are selected based on the rotational speed. Thus, the motor generator having less copper wear can be operated, so that the necessary torque can be maintained as a whole and a power loss due to the drop of the driving efficiency can be prevented.

Next, the PCM 50 determines whether either one of the motor generators is selected or not (step S1516). When either one of the first and second motor generators MG1, MG2 is selected, further determination as to whether the selected one is the first motor generator MG1 or not is conducted (step S1517). When that is the first motor generator MG1, the clutch control device 54 of the PCM 50 connects the first clutch Ch1 and disconnects the second clutch Ch2 (step S1518).

Meanwhile, when both the first and second motor generators MG1, MG2 are selected in the step S1516, or when only the second motor generator MG2 is selected in the step S1517, the clutch control device 54 of the PCM 50 connects both the first and second clutches Ch1, Ch2 (step S1519).

Then, the selected motor generator is driven as the driving source for the charging (step S1520), and the control returns to the main routine.

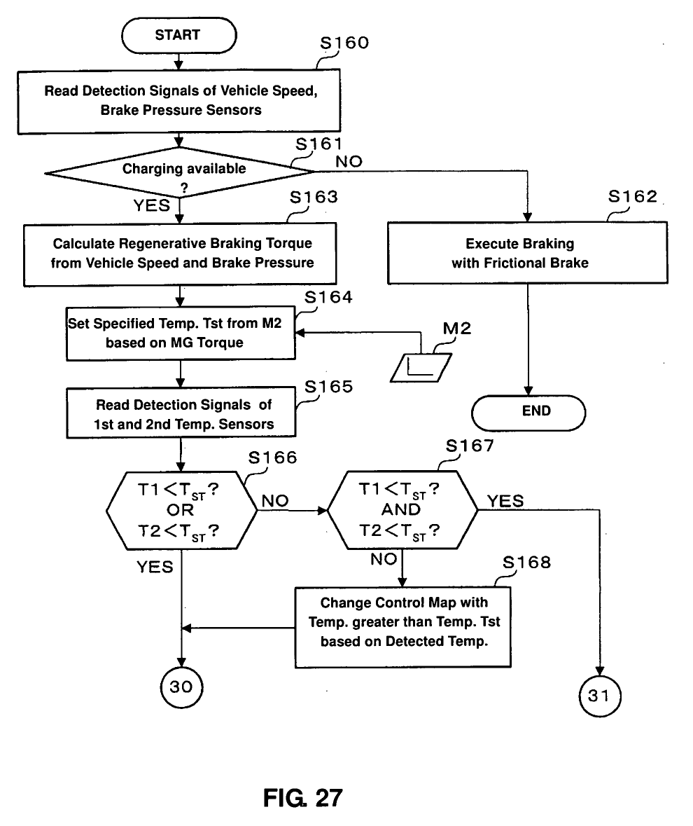

FIGS. 27-29 are flowcharts of an example of regeneration processing at the vehicle deceleration according to the second embodiment.

Referring to FIG. 27, the second embodiment is also configured so that when the vehicle deceleration of the hybrid vehicle 1 is demanded, the regeneration processing of braking and charging of the vehicle by using the first and second motor generators MG1, MG2 is executed under a specified driving state.

The PCM 50, in the regeneration processing, first reads the detection signals of the vehicle speed sensor SW2 and the brake pressure sensor SW4 (step S160) and determines availability of the regeneration processing.

Next, availability of charging is determined based on the detection signal of the battery sensor SW1 in order not to be overcharging of the battery (step S161). When the charging is not available, the brake control device 55 controls the brake control system 35 to execute the braking control with a frictional brake (step S162). Then, the control ends.

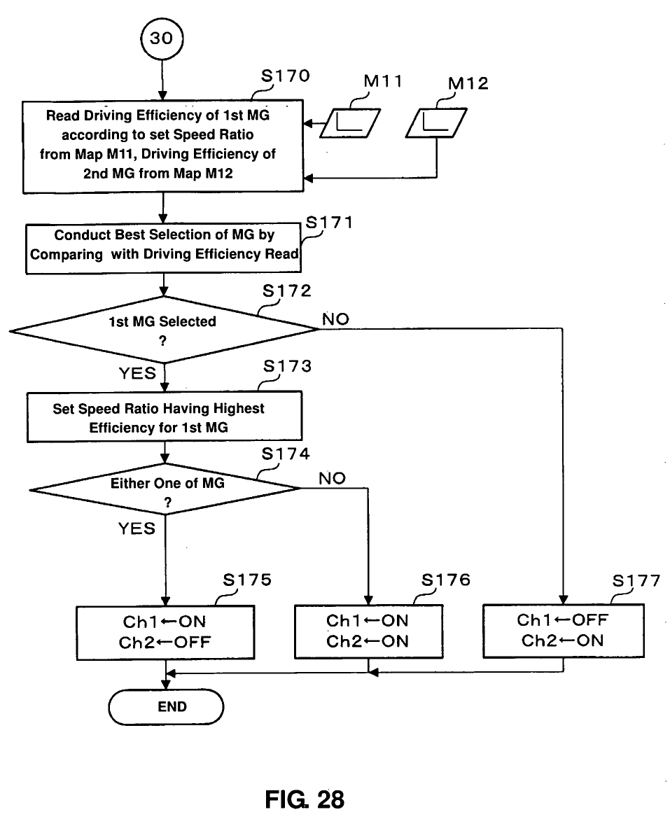

When the charging is available, the PCM 50 calculates a regenerative braking torque based on the vehicle speed and the brake pressure read in the step S160 (step S163). Next, the PCM 50 sets the specified temperature Tₛₜ from the control map M2 based on the whole regenerative braking torque (step S164). Next, the detection signals of the first and second temperature sensors SW5, SW6 are read (step S165), and it is determined whether any one of the detected temperatures T1, T2 of the motor generators MG1, MG2 is less than the specified temperature Tₛₜ or not (step S166). When both the temperatures T1, T2 of the motor generators MG1, MG2 is less than the specified temperature Tₛₜ, the PCM 50 executes processing shown in FIG. 28.

When it is determined that any one of the detected temperatures T1, T2 of the motor generators MG1, MG2 is the specified temperature Tₛₜ or greater in the step S166, the PCM 50 determines whether or not both the temperatures T1, T2 of the motor generators MG1, MG2 are the specified temperature Tₛₜ or greater (step S167).

When it is determined that any one of the detected temperatures T1, T2 of the motor generators MG1, MG2 is less than the specified temperature Tₛₜ in the step S167, the motor-load distribution device 56 of the PCM 50 changes the control map (M11 or M12) with the temperature greater than the specified temperature Tₛₜ based on the detected temperature (step S168). This setting change of the control map can recognize that the above-described motor generator with the high temperature is inferior in efficiency, and thus the rate of operation of this motor generator will reduces.

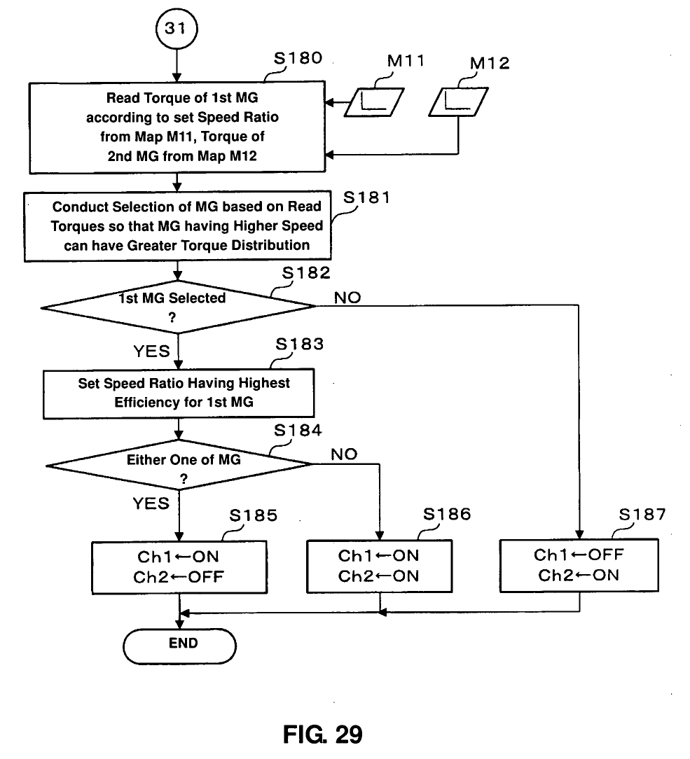

When it is determined that both the detected temperatures T1, T2 of the motor generators MG1, MG2 are the specified temperature Tₛₜ or greater in the step S167, the PCM 50 executes the processing shown in FIG. 29.

Next, referring to FIG. 28, when it is determined that both the detected temperatures T1, T2 of the motor generators MG1, MG2 are less than the specified temperature Tₛₜ in the step S167 of FIG. 27, the PCM 50 reads the driving efficiency of the first motor generator MG1 according to each speed ratio from the control map M11, and reads the driving efficiency of the second motor generator MG2 from the control map M12 (step S170). The PCM 50 compares each driving efficiency read in the step S170 and thereby conducts the selection of the motor generators MG1, MG2 (step S171).

Then, the control of the first and second clutches Ch1, Ch2 is conducted by the selection manner of the motor generators MG1, MG2.

In the regeneration processing, it is determined by the PCM 50 whether the selected one is the first motor generator MG1 or not (step S172). When that is the first motor generator MG1, the speed-ratio setting device 53 of the PCM 50 sets the speed ratio having the highest driving efficiency for the first motor generator MG1 (step S173). Thereby, the transmission electromagnetic valve 18 is driven, so the speed ratio of the transmission 16 is properly changed according to the control executed in the step S67.

Next, the PCM 50 determines whether only the first motor generator MG1 is selected or not (step S174).

When only the first motor generator MG1 is selected, the clutch control device 54 of the PCM 50 connects the first clutch Ch1 and disconnects the second clutch Ch2 (step S175). After this, the battery 34 is charged by the first motor generator MG1 with the braking of the engine 10.

Meanwhile, when the second motor generator MG2 is also selected in the step S174, the clutch control device 54 of the PCM 50 connects both the first and second clutches Ch1, Ch2 (step S176). Thereby, the battery 34 is charged by both the motor generators MG1, MG2.

Further, when the selected motor generator in the step S172 is only the second motor generator MG2, the clutch control device 54 of the PCM 50 disconnects the first clutch Ch1 and disconnects the second clutch Ch2 (step S177). Thereby, the battery 34 is charged by the second motor generator MG2 with the braking of the engine 10.

Next, referring to FIG. 29, when it is determined that both the detected temperatures T1, T2 of the motor generators MG1, MG2 are the specified temperature Tₛₜ or greater in the step S167 of FIG. 27, the driving-source selection device 52 of the PCM 50 reads the torque of the first motor generator MG1 according to each speed ratio from the control map M11, and reads the torque of the second motor generator MG2 from the control map M12 (step S180). The motor-load distribution device 56 of the PCM 50 conducts the selection of the motor generators MG1, MG2 based on the torque read in the step S180 so that the motor generator having the higher rotational speed can have the greater torque distribution (step S181).

Then, the control of the first and second clutches Ch1, Ch2 is conducted by the selection manner of the motor generators MG1, MG2.

In the regeneration processing, it is determined by the PCM 50 whether the selected one is the first motor generator MG1 or not (step S182). When that is the first motor generator MG1, the speed-ratio setting device 53 of the PCM 50 sets the speed ratio having the highest driving efficiency for the first motor generator MG1 (step S183). Thereby, the transmission electromagnetic valve 18 is driven, so the speed ratio of the transmission 16 is properly changed according to the control executed in the step S67.

Next, the PCM 50 determines whether only the first motor generator MG1 is selected or not (step S184).

When only the first motor generator MG1 is selected, the clutch control device 54 of the PCM 50 connects the first clutch Ch1 and disconnects the second clutch Ch2 (step S185). After this, the battery 34 is charged by the first motor generator MG1 with the braking of the engine 10.

Meanwhile, when the second motor generator MG2 is also selected in the step S184, the clutch control device 54 of the PCM 50 connects both the first and second clutches Ch1, Ch2 (step S186). Thereby, the battery 34 is charged by both the motor generators MG1, MG2.

Further, when the selected motor generator in the step S181 is only the second motor generator MG2, the clutch control device 54 of the PCM 50 disconnects the first clutch Ch1 and disconnects the second clutch Ch2 (step S187). Thereby, the battery 34 is charged by the second motor generator MG2 with the braking of the engine 10.

According to the second embodiment, since the distribution of load of the motor generators MG1, MG2 is changed in such a manner that when the temperatures of the motor generators MG1, MG2 is the specified temperature Tₛₜ or greater, the load of the motor generator having the higher temperature is reduced, substantially maintaining the total torque, the damage of the motor generators, such as the copper wear, can be restrained properly maintaining the total torque and the driving efficiency as a whole can be maintained with a lower consumption of electricity.

Further, according to the second embodiment, the motor-load distribution device is configured so that the specific temperature Tₛₜ is adjustable in accordance with demanded load to the motor generators MG1, MG2 in such a manner that the specific temperature Tₛₜ is adjusted to be lower when the demanded load is greater. There is generally a tendency that the temperature of the motor generator MG1, MG2 increases when the demanded load is greater. Accordingly, since the specific temperature Tₛₜ is adjusted in accordance with the demanded load according to the second embodiment, the decrease of the driving efficiency due to the increase of the temperature can be restrained effectively.

Also, according to the second embodiment, there are provided the generator controller 31 as the first rotational speed detection device operative to detect the rotational speed of the first motor generator GM1 and the motor controller 33 as the second rotational speed detection device operative to detect the rotational speed of the second motor generator MG2, and the motor-load distribution device 56 is configured to increase the distribution of the load of the motor generator having the higher rotational speed when the temperature of the motor generators MG1, MG2 that are selected as the driving source is the specified temperature Tₛₜ or greater. Thereby, the output can be obtained efficiently by increasing the distribution of the load of the motor generator with less copper wear. That is, the damage of the copper wear increases when the motor generator has the higher temperature and higher electricity supply, and the efficiency decrease is primarily influenced by the copper wear damage. Accordingly, the efficiency decrease can be restrained properly by increasing the load distribution of the motor generator having the higher rotational speed.

The present invention should not be limited to the above-described embodiments, and any other modifications and improvements may be applied within the scope of a spirit of the present invention.

What is claimed is:

1. A control device of a hybrid vehicle, comprising:
an engine operative to output a driving torque to the vehicle;
a first motor generator operative to generate electricity and output a driving torque to the vehicle, the first motor generator being directly coupled to the engine;
a second motor generator operative to generate electricity and output a driving torque to the vehicle;
a battery operative to supply electricity to the first and second motor generators, the battery being charged by the first and second motor generators;
a driving-state determination device operative to determine a driving state of the vehicle; and
a driving-source selection device operative to select a driving source from the engine, the first motor generator, and the second motor generator based on determination of the driving-state determination device so as to provide the highest driving efficiency as a whole of the vehicle,
wherein the first and second motor generators are configured so that a high-efficiency driving operation area of the first motor generator is set on a higher-speed side relative to a high-efficiency driving operation area of the second motor generator.

2. The control device of a hybrid vehicle of claim 1, wherein the engine and the first motor generator are coupled to a driving shaft of the vehicle via a transmission, and the driving-source selection device is configured so as to determine a driving efficiency of the first motor generator and compare that with a driving efficiency of the second motor generator for each speed ratio of the transmission.

3. The control device of a hybrid vehicle of claim 2, further comprising a speed-ratio setting device operative to set the speed ratio of the transmission at a specified speed ratio that enables the first motor generator to provide a highest driving efficiency thereof when the driving-source selection device selects the first motor generator as the driving source without an operation of the engine.

4. The control device of a hybrid vehicle of claim 3, wherein the speed-ratio setting device is configured to set the speed ratio of the transmission at a specified speed ratio that enables a fuel-consumption efficiency of the engine to provide a highest efficiency when the driving-source selection device selects the engine and the first motor generator as the driving source.

5. The control device of a hybrid vehicle of claim 2, wherein a motor output shaft of the second motor generator is coupled to an output shaft of the transmission, a first clutch is provided between the first motor generator and the transmission, a second clutch is provided at the motor output shaft of the second motor generator, and there is provided a clutch control device operative to control the first and second clutches so as to disconnect the first clutch when the driving-source selection device selects only the second motor generator as the driving source and to disconnect the second clutch when the driving-source selection device excludes the second motor generator from the driving source.

6. The control device of a hybrid vehicle of claim 1, further comprising:
a first temperature detection device operative to detect a temperature of the first motor generator;
a second temperature detection device operative to detect a temperature of the second motor generator; and
a motor-load distribution device operative to determine each temperature state of the first and second motor generators based on detection signals of the first and second temperature detection devices and to change distribution of load of the motor generators in such a manner that when the temperature of the motor generators that are selected as the driving source is a specified temperature or greater, the load of the motor generator having a higher temperature is reduced, substantially maintaining a total torque.

7. The control device of a hybrid vehicle of claim 6, wherein the motor-load distribution device is configured so that the specific temperature is adjustable in accordance with demanded load to the motor generators in such a manner that the specific temperature is adjusted to be lower when the demanded load is greater.

8. The control device of a hybrid vehicle of claim 6, wherein there are provided a first rotational speed detection device operative to detect a rotational speed of the first motor generator and a second rotational speed detection device operative to detect a rotational speed of the second motor generator, and the motor-load distribution device is configured to increase the distribution of the load of the motor generator having a higher rotational speed when the temperature of the motor generators that are selected as the driving source is a specified temperature or greater.

9. A control method of a hybrid vehicle that includes an engine operative to output a driving torque to the vehicle, a first motor generator operative to generate electricity and output a driving torque to the vehicle, the first motor generator being directly coupled to the engine, a second motor generator operative to generate electricity and output a driving torque to the vehicle, a high-efficiency driving operation area of the second motor generator being set on a lower-speed side relative to a high-efficiency driving operation area of the first motor generator, and a battery operative to supply electricity to the first and second motor generators, the battery being charged by the first and second motor generators, the control method comprising:
a first step of selecting a driving source from the engine, the first motor generator, and the second motor generator so as to provide the highest driving efficiency as a whole of the vehicle; and
a second step of operate the selected driving source that is selected by the first step.

10. The control method of a hybrid vehicle of claim 9, wherein the engine and the first motor generator are coupled to a driving shaft of the vehicle via a transmission, and the first step comprises a step of determining a driving efficiency of the first motor generator and comparing that with a driving efficiency of the second motor generator for each speed ratio of the transmission.

11. The control method of a hybrid vehicle of claim 10, further comprising a third step of setting the speed ratio of the transmission at a specified speed ratio that enables the first motor generator to provide a highest driving efficiency thereof when the first motor generator is selected as the driving source in the first step.

12. The control method of a hybrid vehicle of claim 11, wherein the third step is configured to set the speed ratio of the transmission at a specified speed ratio that enables a fuel-consumption efficiency of the engine to provide a highest efficiency when the engine and the first motor generator are selected as the driving source in the first step.

13. The control method of a hybrid vehicle of claim 10, wherein a motor output shaft of the second motor generator is coupled to an output shaft of the transmission, a first clutch is provided between the first motor generator and the transmission, a second clutch is provided at the motor output shaft of the second motor generator, and there is provided a clutch control device operative to control the first and second clutches so as to disconnect the first clutch when only the second motor generator is selected as the driving source in the first step and to disconnect the second clutch when the second motor generator is not selected as the driving source in the first step.

14. The control method of a hybrid vehicle of claim 9, wherein the hybrid vehicle further comprises a first temperature detection device operative to detect a temperature of the first motor generator, and a second temperature detection device operative to detect a temperature of the second motor generator, and there is provided a fourth step of determining each temperature state of the first and second motor generators based on detection signals of the first and second temperature detection devices and changing distribution of load of the motor generators in such a manner that when the temperature of the motor generators that are selected as the driving source is a specified temperature or greater, the load of the motor generator having a higher temperature is reduced, substantially maintaining a total torque.

15. The control method of a hybrid vehicle of claim 14, wherein the fourth step is configured so that the specific temperature is adjustable in accordance with demanded load to the motor generators in such a manner that the specific temperature is adjusted to be lower when the demanded load is greater.

16. The control method of a hybrid vehicle of claim 14, wherein the hybrid vehicle further comprises a first rotational speed detection device operative to detect a rotational speed of the first motor generator and a second rotational speed detection device operative to detect a rotational speed of the second motor generator, and the fourth step is configured to increase the distribution of the load of the motor generator having a higher rotational speed when the temperature of the motor generators that are selected as the driving source is a specified temperature or greater.
